(19) United States
(12) Patent Application Publication
(10) Pub. No.: US 2011/0097218 A1
(43) Pub. Date: Apr. 28, 2011

(54) METHOD AND APPARATUS FOR GENERATING A FLUID FLOW

(76) Inventor: GERALD H. POLLACK, SEATTLE, WA (US)

(21) Appl. No.: 12/908,557

(22) Filed: Oct. 20, 2010

Related U.S. Application Data
(60) Provisional application No. 61/253,799, filed on Oct. 21, 2009.

(51) Int. Cl. F04B 53/00; F15D 1/00

(52) U.S. Cl. 417/53; 137/565.01; 137/803

(57) ABSTRACT

An apparatus includes a hydrophilic surface configured to drive flow of a polar fluid responsive to an exclusion zone (EZ) effect, the EZ being formed near the hydrophilic surface. An energy source may provide energy to form or maintain the EZ.

### CROSS-REFERENCE TO RELATED APPLICATIONS

The present application claims priority benefit from, and to the extent not inconsistent with the disclosure herein, incorporates by reference U.S. Provisional Patent Application Ser. No. 61/253,799; invented by Gerald H. Pollack; entitled Method and Apparatus for Generating a Fluid Flow, and filed on Oct. 21, 2009, which is co-pending at the date of this filing.

### BACKGROUND

Previous academic work has described the phenomenon of an exclusion zone (EZ) generated in proximity to a hydrophilic surface.

### SUMMARY

According to embodiments, methods and applications are described for attaining useful fluid flows in various practical devices. The fluid flows are driven via the generation of an exclusion zone (EZ) in a polar fluid in proximity to a hydrophilic surface. The flows may be produced substantially without conventional energy input, and have been found to persist for extended periods of time.

According to an embodiment, fluid flow may be maintained responsive to energy absorbed from the environment. Such absorbed energy may be converted to an entropic gradient that maintains the fluid flow.

According to an embodiment, a fluid flow generator includes a tube having an inner wall, an inlet end, and an output end. A hydrophilic surface formed on at least a portion of the inner wall of the tube. The hydrophilic surface of the inner wall is configured to form a proximate exclusion zone in polar fluid in the tube, and the exclusion zone provides a propulsive force to drive fluid flow from the inlet end to the output end of the tube.

According to an embodiment, a fluid flow generator includes a tube having an inlet end, an output end, and an inner wall including at least a portion that is hydrophilic; a first fluid reservoir coupled to admit a polar fluid to the inlet end of the tube; and a second fluid reservoir coupled to receive the polar fluid from the output end of the tube. The hydrophilic portion of the inner wall is configured to form an exclusion zone in fluid in the tube, the exclusion zone providing a propulsive force to drive fluid flow from the first fluid reservoir to the second fluid reservoir.

According to an embodiment, a propulsion system includes a tube having an inlet end, an output end, and an inner wall including at least a portion that is hydrophilic. A mount coupled to the tube may be configured to operatively couple to a propelled vessel. The hydrophilic portion of the inner wall is configured to form an exclusion zone in fluid in the tube, the exclusion zone providing a propulsive force to drive the propelled vessel through a polar fluid.

According to an embodiment, a method for pumping a polar fluid includes contacting a polar fluid with at least one hydrophilic surface, forming at least one exclusion zone in the polar fluid proximate to the hydrophilic surface, forming a difference in the thickness of different regions of the at least one exclusion zone, and propelling the polar fluid from a volume proximate a thick region of the at least one exclusion zone to a volume proximate a thin region of the at least one exclusion zone.

According to an embodiment, a method of mixing a fluid includes providing a body having a hydrophilic surface, providing a fluid reservoir configured to hold a polar fluid, providing a polar fluid in the fluid reservoir, and at least partially submerging the body in the polar fluid in the reservoir. The hydrophilic surface of the body forms an exclusion zone in the polar fluid in the reservoir, and the exclusion zone provides a propulsive force to drive fluid flow along the hydrophilic surface.

According to an embodiment, a body configured to drive polar fluid to flow past the body includes a body having an external surface and a hydrophilic surface formed on at least a portion of the external surface, wherein the hydrophilic surface is configured to form a proximate exclusion zone in polar fluid adjacent the body, and the exclusion zone provides a propulsive force to drive polar fluid flow substantially parallel to the surface of the body.

According to an embodiment, a method of drawing fluid into a tank includes providing a tank having a hydrophilic inner surface, providing a fluid passage through a wall of the tank, and introducing a polar fluid to the outside of the wall of the tank in the vicinity of the fluid passage. The hydrophilic surface forms an exclusion zone in polar fluid in the tank, the exclusion zone providing a propulsive force to pull the polar fluid into the tank.

### BRIEF DESCRIPTION OF THE FIGURES

FIG. 1 is a diagram of a fluid flow generator, according to an embodiment.

FIG. 2A is a sectional diagram of a portion of the tube of FIG. 1, according to an embodiment.

FIG. 2B is a sectional diagram of a portion of the tube of FIG. 1 under conditions of fluid flow past the hydrophilic surface with a differential EZ characteristic, according to an embodiment.

FIG. 3 is a flow chart summarizing the fluid flow generation process used by apparatuses that operate according to principles described in conjunction with FIGS. 1, 2A, and 2B, according to an embodiment.

FIG. 4 is a diagram of a fluid propulsion system and a propelled vessel, according to an embodiment.

FIG. 5 is a diagram of an EZ fluid mixer, according to an embodiment.

FIG. 6 is a diagram of a system for drawing fluid into a tank using the EZ flow effect, according to an embodiment.

FIG. 7 is a diagram of a piston engine configured to be driven by an EZ flow effect, according to an embodiment.

FIG. 8 is a diagram of a multi-stage fluid pump based on principles disclosed herein, according to an embodiment.

FIG. 9 is a block diagram of an EZ-based power generation system, according to an embodiment.

FIG. 10 is a photograph of a positively charged hydrophilic bead in a water suspension of negatively charged microspheres.

FIG. 11 is a series of graphs showing microsphere velocity as a function of distance from the hydrophilic bead surface.

FIG. 12A is a photograph of a hydrophilic bead at the start of an experiment.

FIG. 12B is a photograph of the hydrophilic bead of FIG. 12A after 1 hour.

FIG. 12C is a close-up photograph of the hydrophilic bead of FIG. 12B showing a structure of 0.47 um microspheres attracted thereto.

FIG. 13 is a photograph showing an EZ formed between a negatively charged bead and negatively charged microspheres.

FIG. 14 is a set of graphs showing negatively charged microsphere velocity as a function of distance from the negatively charged bead surface.

FIG. 15A is a photograph of a negatively charged bead surface in a solution of negatively charged microspheres at an initial time t=0.

FIG. 15B is a photograph of the negatively charged bead surface of FIG. 15A in the suspension of negatively charged microspheres at a time t=2 hours.

FIG. 15C is a photograph of the negatively charged bead surface of FIGS. 15A, 15B in the suspension of negatively charged microspheres at a time t=5 hours.

FIG. 15D is a photograph of a negatively charged bead surface of FIGS. 15A-15C in the suspension of negatively charged microspheres at a time t=24 hours.

FIG. 16A is a photograph of a Nafion tube in a solution of microspheres just before puncture.

FIG. 16B is a photograph of the Nafion tube of FIG. 16A in the solution of microspheres just after puncture.

FIG. 17 is a graph of flow rate into the tube of FIGS. 16A, 16B as a function of time.

FIG. 18 is a graph of flow rates as a function of time into the tube of FIGS. 16A, 16B, first with a single hole and just after puncture of a second hole approximately 1 cm away.

FIG. 19A is a graph of microsphere flux into the tube of FIGS. 16A, 16B superimposed over relative EZ size inside the tube as a function of time.

FIG. 19B is a graph of microsphere flux into the tube of FIGS. 16A, 16B superimposed over relative EZ size outside the tube as a function of time.

FIG. 20 is a graph showing flow of a solution of water and microspheres into the tube of FIGS. 16A, 16B as a function of time with 0.01M NaOH solution inside tube.

FIG. 21 is a graph showing flow of a solution of water and microspheres into the tube as a function of time with 0.01 M HCl microsphere suspension inside tube.

### DETAILED DESCRIPTION

In the following detailed description, reference is made to the accompanying drawings, which form a part hereof. In the drawings, similar symbols typically identify similar components, unless context dictates otherwise. Other embodiments may be used and/or other changes may be made without departing from the spirit or scope of the disclosure.

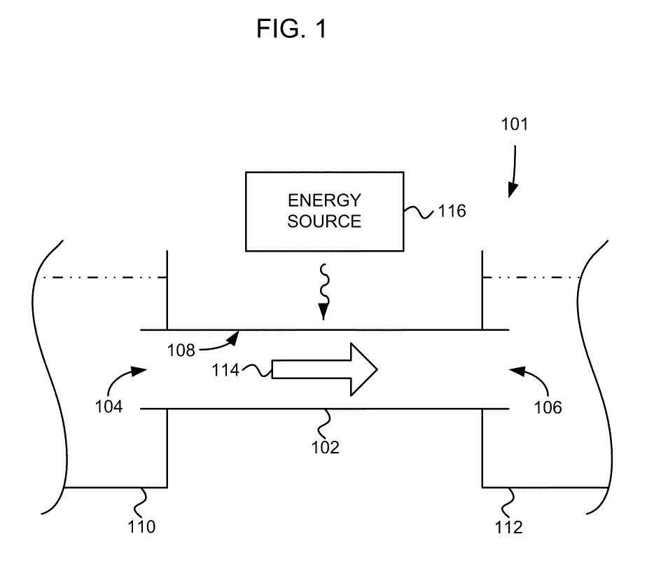

FIG. 1 is a diagram of a fluid flow generator 101 configured to pump a polar fluid between reservoirs, according to an embodiment. The fluid flow generator 101 includes a tube 102 having an inlet end 104, an output end 106, and an inner wall 108 including at least a portion that is hydrophilic. A first fluid reservoir 110 may be coupled to admit a polar fluid to the inlet end 104 of the tube 102. A second fluid reservoir 112 may be coupled to receive the polar fluid from the output end 106 of the tube 102. A fluid flow 114 from the inlet 104 to the output 106 of the tube 102 is maintained responsive to interactions between the polar fluid and the hydrophilic surface 108 of the tube 102. The fluid flow 114 may transfer a polar fluid from the first fluid reservoir 110 to the second fluid reservoir 112. Optionally, a plurality of tubes 102 may be disposed in parallel such that each is configured to receive the polar fluid from the same source first reservoir 110 and output the polar fluid to substantially the same destination second fluid reservoir 112.

A number of polar fluids were found to exhibit the flow described herein. For example, the polar fluid may include water, a polar fluid with one or more solutes, water with one or more solutes, a polar fluid with one or more suspended particle types, water with one or more suspended particle types, an alcohol, ethanol, a carboxylic acid, acetic acid, dimethyl sulfoxide, or deuterium oxide. For ease of understanding, the polar fluid will generally be referred to as water herein, but it is to be understood that other polar fluids may be substituted.

Optionally, an energy source 116 may provide energy to maintain fluid flow 114 over an extended period of time or to hasten formation of the EZ. The energy source 116 may be an explicit part of the structure of the fluid flow generator 116. Alternatively, the energy source may be inherent in the ambient environment of the fluid flow generator 116. For example, black body radiation from surrounding objects may provide energy to the tube 102 and the fluid therein.

The tube 102 may be made of a hydrophilic material such as Nafion or a polyacrylic-acid gel. Nafion is a sulfonated tetrafluoroethylene based fluoropolymer copolymer having a formula:

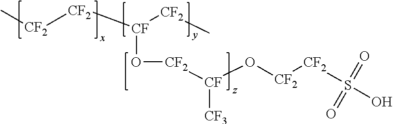

The name Nafion will be used herein. It will be understood that compounds related to Nafion may be substituted without departing from the spirit or scope of the claims. Other hydrophilic surfaces may be used in other embodiments. The tube 102 may be horizontal or it may be tilted in the vertical plane by various degrees. In another embodiment, the output end 106 may extend out of the fluid, for example where the surface of the fluid in the second reservoir 112 is below the level of the output 106. For embodiments where the output end 106 is above the surface of the fluid in the second reservoir, the tube 102 may be inclined to raise the fluid to a level above the surface of the fluid in the first reservoir 110. It was found that extending the output end 106 out of the fluid increases the flow velocity significantly. The tube 102 may be cylindrical, elliptical, rectangular, or have other shapes in cross section, for example.

The fluid level in the first reservoir 110 may be lower than, equal to, or greater than the fluid level in the second reservoir 112. Hence, the fluid can flow against a hydrostatic pressure gradient. The tube 102 may include a plurality of tubes corresponding to plural stages of a fluid transmission or lift distance.

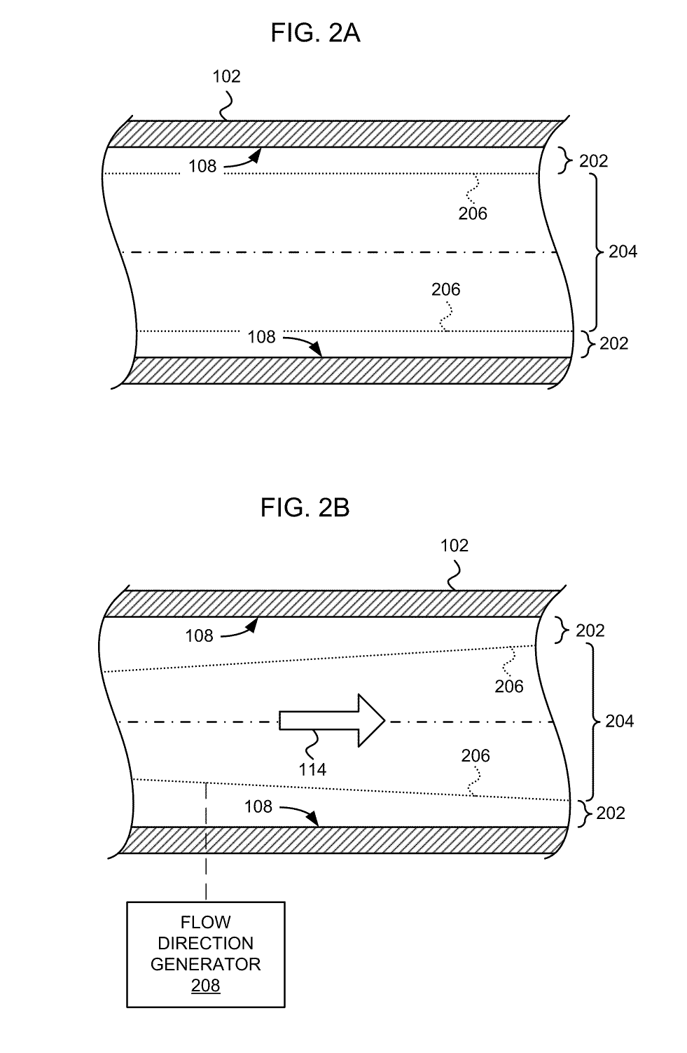

FIG. 2A is a side sectional diagram of a portion of the tube 102 of FIG. 1, according to an embodiment. The hydrophilic portion (which may include substantially the entirety) of the inner wall 108 is configured to form an exclusion zone (EZ) 202 in a polar fluid in the tube. The EZ provides a propulsive force to drive fluid flow, for example from the first fluid reservoir 110 to the second fluid reservoir 112 shown in FIG. 1.

Water next to hydrophilic surfaces 108, the EZ 202, has characteristics that differ from bulk water 204. Unlike bulk water 204, the EZ 202 excludes particles and solutes. It is therefore referred to as the exclusion zone or EZ. The EZ 202 may be extensive, and was found to frequently project up to hundreds of micrometers from the hydrophilic surface 108. The EZ 202 is more stable and more ordered than bulk water 204, and it was also found to carry a net charge. The bulk water 204 immediately beyond the EZ 202 was found to be oppositely charged from the EZ 202.

The separation of charge across an interface 206 between the EZ 202 and the bulk water region 204 may be regarded as a battery cell or capacitor. The electrical potential across the interface 206 can be used to drive current flow. Additionally or alternatively, the potential can generate mechanical work in the form of charge-driven flow by mechanisms described herein. The battery may gain energy by absorbing incident light in a manner akin to a photovoltaic photocell: i.e., light incident on the EZ 202 or regions 204 nearby builds the size of the EZ 202, and hence builds the charge separation. In some experiments, infrared wavelengths were found to be most effective at adding energy to the EZ 202, UV wavelengths were found to be somewhat less effective than infrared, and visible wavelengths were found to be least effective. However, the relative effectiveness of different wavelengths of electromagnetic radiation is still under investigation. Moreover, the EZ 202 was found to form and drive flow even with no explicit source of electromagnetic radiation.

All EZ-generating surfaces tested thus far produce flow. All non-EZ-generating surfaces such as tubes made of hydrophobic materials failed to produce flow. Surfaces that ordinarily produce exclusion zones but which were subject to conditions in which the EZs are eliminated failed to produce flow. Hence EZ-based features are understood to play a role in the energy-transduction mechanism.

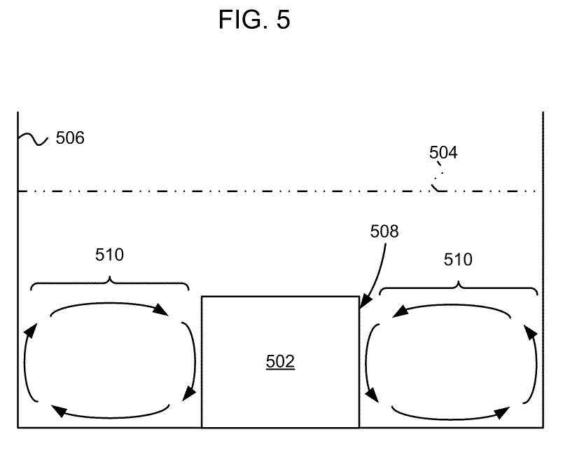

FIG. 2B is a side sectional diagram of a portion of the tube 102 of FIG. 1 under conditions of fluid flow past the hydrophilic wall 108, according to an embodiment. The EZ 202 is generally an annular region near the hydrophilic wall 108 that in the case of a cylindrical tube 102 is cylindrically symmetric. While FIG. 2B illustrates flow inside the tube 102, similar principles apply in other cases of flow along hydrophilic surfaces. That is, flow can similarly be generated by an EZ 202 formed on an exterior hydrophilic surface. An embodiment of this is described more fully in conjunction with FIG. 5.

Referring again to FIG. 2B, when the tube 102 was immersed in water or filled with water (or another polar fluid) the annular EZ 202 shown in FIG. 2A established itself along the tube 102. Within minutes, one or more characteristics of the EZ 202 may form a differential value, shown as an exaggerated taper in FIG. 2B. In experiments, it was observed that the size of the EZ 202 diminished with distance along the tube. This was observed with both Nafion tubes and polyacrylic acid tubes. Alternatively, the EZ may not physically taper, but may be characterized by another differential or gradient such as charge mobility, degree of order within the EZ, or another aspect that accounts for energy exchange and the observed flow behavior. Because the flow was experimentally found to coincide with a physical size taper, description and claims will refer to taper and will be modeled as a physical taper herein. However, as used herein, “exclusion zone taper” will be understood to refer to a gradient in an EZ property along the hydrophilic surface. Accordingly, the EZ may taper down from the inlet end 104 to the to the output end 106 of the tube 102.

One explanation of the observed flow behavior may be understood by reference to the energy contained in a wide EZ versus a narrow EZ 202. The direction of flow through the tube 102 may correspond to flow from a region having a wide EZ to a region having a narrower EZ. Wider EZs may contain more charge than narrower EZs. In observed situations the charge polarity of the EZ was consistently negative; hence, if the near-entry EZ is wider than the near-exit EZ, then the near-entry EZ will contain relatively more negative charge. The near-exit EZ will contain relatively less negative charge.

According to one explanation, a consideration is the battery-like feature described above. Wherever there is negative charge in the EZ 202, there is corresponding positive charge in the region beyond 204. The corresponding positive charge has been experimentally confirmed. Hence, the core 204 of the tube 102 can contain positive charge. This positive charge may be highest at the entry, lowest at the exit. Whereas the negative charge is embedded in the structural matrix of the EZ, the positive charge is in the form of free hydronium ions, i.e., protonated, or positively charged water; and thus the positive charge is freely mobile. Hence, the concentration of positively charged water ions may be higher at the entry than at the exit. Looked at from one perspective, this charge gradient may drive the water through the tube.

According to a thermodynamic model, a wide EZ 202 state represents a lower entropy than a narrow EZ 202 state. Fluid in the tube 102 flows left-to-right as illustrated to move from a low entropy state to high entropy state.

The direction of the taper of the exclusion zone 202 may be random. For example, this may be useful if the tube 102 is used to circulate water in a contiguous tank, such as a single tank or two tanks also coupled by a second passage. The second passage may include an EZ pump or may respond to a slight hydrostatic pressure difference caused by the EZ pump 102. In such an arrangement, the direction of circulation may not be important. Moreover, the direction of flow may or may not correspond to the direction of taper.

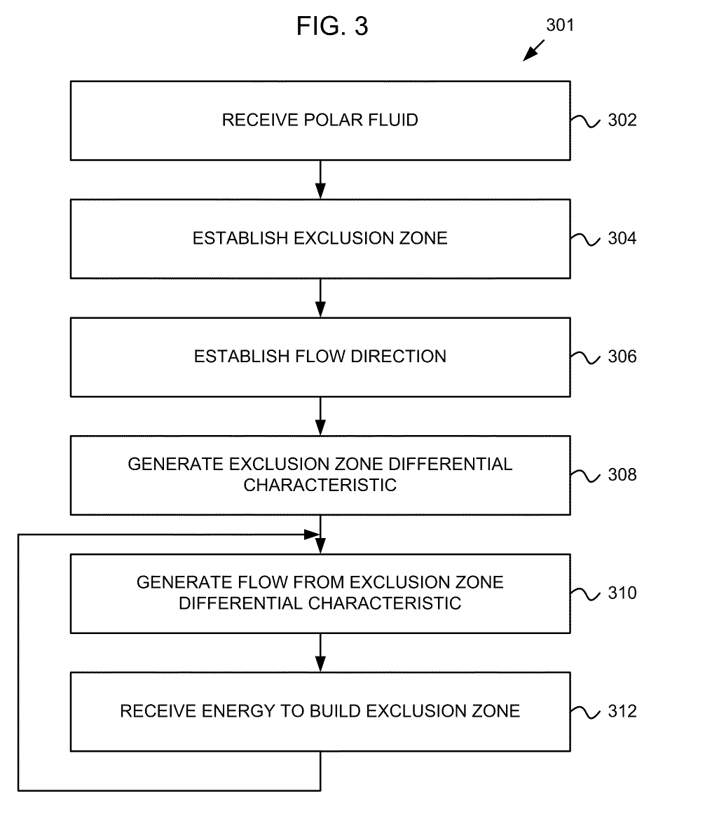

Alternatively, a flow direction generator 208 may be used to generate a direction of flow 114 (shown from left-to-right in FIG. 2B). The flow direction generator 208, shown for simplicity as a separate object, may be intrinsically incorporated into the tube 102 or the hydrophilic surface 108, such as by tapering the tube 102 or providing a differential hydrophilicity or varying the surface area of the hydrophilic surface 108 from one end to the other of the tube 102. Separate flow direction generators 208 may include, for example, a small auxiliary pump, a differentially applied energy source 116, a separate motive power source, etc. The determination of flow direction (including a formation of EZ characteristic differential) is described more fully in conjunction with FIG. 3. The flow direction generator 208 may be an exclusion zone taper generator.

Alternatively, the pump configuration of FIGS. 1, 2A, and 2B (and other embodiments shown herein) may be used to boost the efficiency or output of a conventional pump. In this mode, a conventional pump may be used to provide a portion of the fluid pumping, with EZ-driven pumping providing additional energy. For example, this approach may be envisioned as an embodiment where the flow direction generator 208 of FIG. 2B includes a conventional fluid pump, but where the flow direction generator is not shut off after establishing the direction of flow.

FIG. 3 is a flow chart 301 summarizing the fluid flow generation process used by apparatuses that operate according to principles described in conjunction with FIGS. 1, 2A, and 2B, according to an embodiment. In step 302, a polar fluid is received adjacent to a hydrophilic surface. For example the hydrophilic surface may be the inside of a tube, as described above. Alternatively, the hydrophilic surface may be on a body configured to be placed in a tank to cause mixing, or on one or more walls of a fluid passage into or within a tank, as described below.

Proceeding to step 304, an EZ is established. Establishment of an EZ may occur substantially spontaneously. Alternatively, the EZ may be established in concert with receipt of incident energy by the fluid. It has been experimentally confirmed that EZ formation is particularly responsive to ultrasonic and sonic energy. According to embodiments, electromagnetic radiation, applied sonic energy, and/or other forms of transmitted energy may provide a catalyst function and/or contribute energy to the EZ state. Some or all of the entropic energy of the EZ may correspond to a conversion from molecular kinetic energy corresponding to the temperature of the fluid.

Next, in step 306, a direction of flow is established. According to some embodiments, for example in mixing applications, the direction of flow through the tube may be of minor importance. For example, the flow of the polar fluid may be bidirectional and the inlet and output ends of the tube may be interchangeable. A straight tube with a uniformly hydrophilic wall, with no impressed motion, and with no differential incident energy from an energy source may exhibit a substantially random flow direction. In such a case, minor temperature gradients or other perturbations to Brownian motion may result in a small net movement of fluid through at least a portion of the tube. In such a case, a very slight EZ characteristic differential may arise. The slight EZ characteristic differential may tend to amplify itself as a greater and greater fluid flow rate increases the slope or difference in the characteristic. The generation of a differential value in an exclusion zone characteristic is shown in step 308. However, one should realize that steps 306 and 308 may proceed substantially simultaneously. Steps 306 and 308 are shown as separate steps for clarity of description. According to experimental observations, the differential characteristic may be the thickness of the exclusion zone.

Reversal of fluid flow direction has not been observed experimentally. Rather, once flow was established, flow direction remained constant, although variations in flow rate were observed. The Examples provide information regarding observed flow responses.

Alternatively, the direction of flow may be set. Flow direction can be set in a number of ways. In uniform tubes in a quiescent fluid, flow direction may be unpredictable; but once begun, it continues indefinitely in the initial direction. Flow direction may be set by tapering all or a portion of the tube, such that the tube has a varying diameter. In tapered tubes, flow was confirmed to proceed from large to small diameter; hence flow direction can be set by tapering the tube, either gradually, or more abruptly as in a step function. Alternatively, the wall may be formed with a differential hydrophilicity. More hydrophilic surfaces, e.g., those that are highly charged, were found to generate larger EZs. Hence by grading the degree of hydrophilicity along the tube, either progressively as in a gradient, in a step, or as a combination; one can set flow direction. For example, direction of flow may be set by providing larger hydrophilicity at the inlet end of a surface or tube than the hydrophilicity at the output end of the surface or tube.

Alternatively, a conventional pump may be configured to set a direction of fluid flow from the inlet end of the tube to the output end of the tube. Once flow is started in a direction, it continues in that direction. Alternatively, the inlet end of the tube may be energized, such as by illumination with higher intensity light than the output end (or the output end may be shaded). The higher intensity light may drive formation of a larger EZ, which may tend to generate a flow direction from the inlet to the output end of the tube.

As indicated above, the direction of flow has been experimentally observed to correspond to the direction of an EZ taper. Flows have been observed to progress from a region of large EZ thickness to a region or smaller EZ thickness. Accordingly, it has been hypothesized that the observed EZ taper is responsible for driving flow.

Proceeding to step 310, flow is generated and maintained from the EZ taper. The flow in the tube was observed to continue without substantial diminution of speed, for at least one hour.

While many experiments were performed without any identifiable energy source 116, it is believed that energy was provided by the environment, for example in the form of incident radiation or inherent in molecular behavior corresponding to temperature, e.g. corresponding to vibrational, rotational, and/or translational movement of fluid molecules.

Accordingly, the process 301 includes step 312, wherein the fluid in the tube, and the EZ in particular, receives energy from the environment or from an explicit energy source. For example, the tube may be configured to receive radiant electromagnetic energy, sonic energy, or ultrasonic energy and responsively maintain the exclusion zone and the propulsive force. For example, the tube may be configured to receive radiant energy having 3100 nanometers wavelength. The apparatus shown in FIG. 1 (and other apparatuses shown below) may include a radiant energy source 116 configured to provide the radiant energy to the tube. For example the energy source 116 may include an infrared or ultraviolet LED or LED array. Alternatively, an energy source 116 may include a sonic or ultrasonic compression wave source.

Placement of step 312 is indicated as falling outside the linear progression of steps 302 to 310. According to one interpretation, step 312 may proceed substantially continuously, forming an exchange medium with the entropy state of the EZ and the translational motion of the fluid in the tube 102. According to another interpretation, step 312 may occur in concert with one or more of steps 302 to 310. For example, energy may flow into formation 304 of the EZ 202 and into maintenance of the EZ during fluid flow 310.

Referring again to FIG. 1, the first and second reservoirs may be operatively coupled for fluid flow therebetween via a flow channel separate from the tube 102. For example, fluid may re-circulate from the output reservoir 112 to the inlet reservoir 110 through another flow generator 101 configured to drive the fluid via the EZ mechanism, through a conventional pump, or via natural flow through a non-powered passage. Alternatively, the first and second reservoirs may be contiguous, such as in a mixer or other apparatus configured to provide flow within a vessel. An example is a fish tank circulation pump.

The apparatus described in conjunction with FIG. 1 may be used in a variety of applications. For example, the fluid flow generator may be a portion of an irrigation system. Such an application may be represented by the apparatus 101 wherein water in a tank 110 may be transported to sites 112 where it is needed. The transport tubes 102 are hydrophilic and built so that the flow direction is away from the tank 110. In one embodiment these sites 112 are agricultural sites. In other embodiments they are other types of sites 112 requiring water. According to an embodiment, the tank need not be elevated to create hydrostatic pressure. According to an embodiment the driving energy comes from the sun. According to an embodiment, a solar collector may serve as a power source 116 according to the EZ phenomenon. Optionally, a birefringent filter may couple light into the solar collection region in the vicinity of the tube 102. For example, such a filter may couple light at wavelengths to which the EZ responds to the EZ, and couple other wavelengths to other solar energy conversion apparatus(es). Using solar power, source logistics may be simplified. Another advantage is that flow appears likely to be maximal during hot periods, when water is needed most, and minimal during cooler periods when it is needed least. Hence, the delivery could match demand in a natural way, e.g., with no need for the complexities of external flow regulation structure.

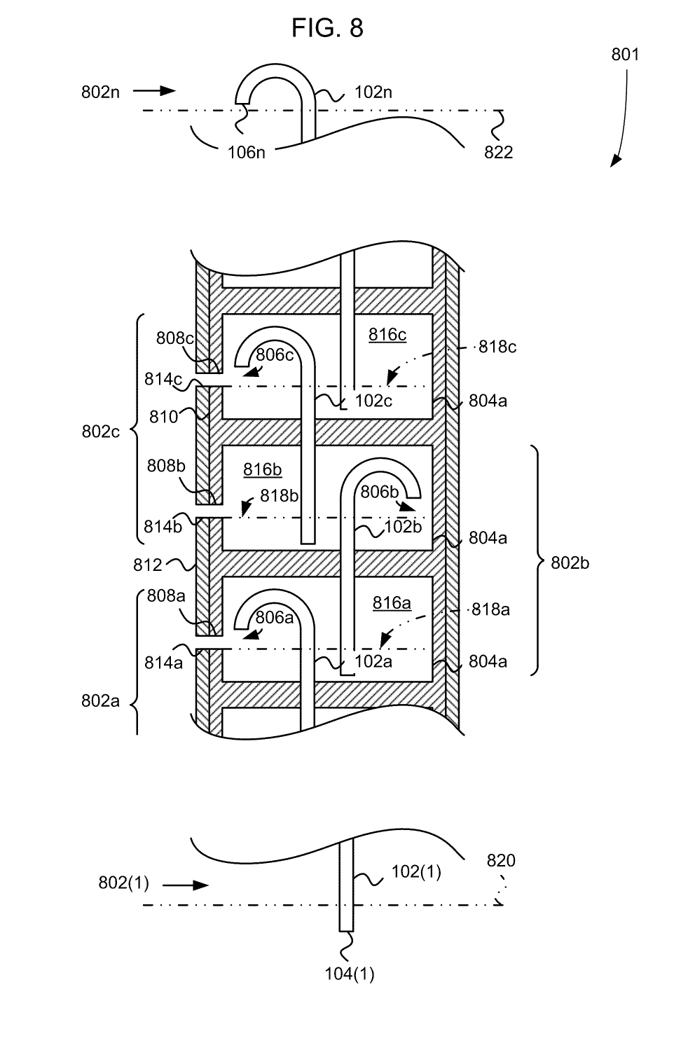

The fluid flow generator may be a portion of a water transport system from an aquifer or cistern. Such an application may be represented by the apparatus 101 wherein water can be transported upward from an underground aquifer, cistern, or container 110 to sites 112 at ground level where it is needed. Such sites may include but are not limited to homes, factories, villages, and agricultural areas. According to an embodiment, no explicit external power source 116 is needed. According to another embodiment, a radiant energy source 116 may provide radiant energy to pump the EZ. Such a source may include a light pipe. In one embodiment the hydrophilic tube 102 runs from the source 110 directly to a collecting tank 112. In another embodiment the water receiving location(s) may correspond to a pipe network or other liquid volume that may not resemble a tank or identifiable bulk reservoir. For example, the intake 110 and output 112 reservoirs may be respectively or commonly comprised of a porous medium. In situations in which the height difference between water source 110 and output 112 is too great, intermediate reservoirs may be staged in a plurality. For example, intermediate reservoirs may be staged at distances corresponding to a desired EZ taper 206 (FIG. 2B). An embodiment of a fluid pump including multiple stages (and intermediate reservoirs) is described more fully in conjunction with FIG. 8.

The fluid flow generator may be a portion of an infusion device, such as a medical device configured to pump fluid into a human body or within a human body. Such an application may be represented by the apparatus 101 wherein drugs and/or other solutes and fluids may be infused from a chamber 110 to specific body sites 112. The chamber 110 may be situated within the body or adjacent the skin of the person or test subject. The transport tube 102 is made of a biocompatible material. In one embodiment the material is polyHEMA, which, for example, is used in soft contact lenses, and has been shown to exhibit substantial exclusion zones. The infusion may occur without need for a battery or pump separate from the tube(s) 102. The principle is applicable in a situation requiring slow infusion of a polar liquid, with or without dissolved solutes or suspended particles.

The fluid flow generator may be a portion of a toy or amusement. Because the propulsion mechanism is counter-intuitive, people observing the flow phenomena outlined above are often astonished. The astonishment opens an opportunity for creating children's toys and adult amusements. One embodiment is a boat-like device that self-propels. Another embodiment is a fountain or water feature that spews water upward or sideways or some combination thereof, from a body of water, the latter either natural or supplied in a container 110.

Further, since artificial light can drive the flow just as well as natural light, the toys and amusements, as well as other devices, can be made to function only when the lights are turned on. This can be achieved by designing the system in such a way that there is a threshold for flow, which is exceeded only when lights are turned on.

The fluid flow generator may be a portion of a heating system, cooling system, or heating and cooling system. A design constraint in electronic integrated circuit development is heat generation. Because infrared radiation is particularly effective at building EZs, and EZs drive flow, fluid channels built directly into, or around, IC chips may be driven by blackbody radiation, conducted, or convective heat transfer from the integrated circuit and/or packaging. Accordingly, flow rate, which depends on EZ formation, may provide an indication of a rate of radiation, which is dependent upon blackbody temperature. (Adjustments may be made for non-ideal behavior.) According to an embodiment, the tube 102 may form a portion of a temperature sensor.

When used for heat exchange purposes, a portion of the generated heat (especially one or more portions corresponding to global or local maximum response) may drive flow. The heat transferred to the fluid could thereby pass through a heat exchanger and transfer the heat to the surrounding air.

Chip cooling may be represented by the apparatus 101 wherein 110 corresponds to a heat source and 112 to a heat sink such as a liquid-to-air heat exchanger. The tube 102 may be formed in an IC or IC packaging in a continuous fashion. The continuous tube may be represented by a second tube (not shown) configured to carry fluid from location 112 to location 110. The tube is filled with water or another polar liquid. The tube may for example be etched substantially square or as a truncated pyramid in the IC substrate. The top may correspond to the IC package. One or more of the top, bottom, or the sides of the tube 102 may be hydrophilic or coated with a hydrophilic material. The other surfaces may be hydrophobic. In some embodiments, directionality does not matter; however, if desired, the water-flow direction may be predetermined by imposing a hydrophilic taper or step function, or size taper or step function.

The channel 102 may be built into the IC substrate, such as in flow channels etched into the wafer back during or prior to IC manufacture. Since flow can be generated past a single hydrophilic surface, only one of the four flat surfaces of the channel needs to contain the hydrophilic material. This same principle can be applied, in other embodiments, to cool other heat-generating devices such as an engine or motor.

Alternatively, the fluid flow generator may be a portion of a fluid mixing system. FIG. 5 illustrates one embodiment. Alternatively, the fluid flow generator may be a portion of an aquarium circulation system, which may be represented by FIG. 1, in a manner analogous to applications described above.

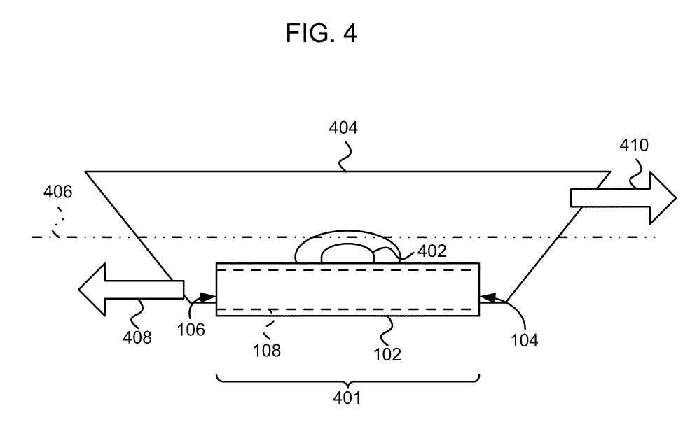

FIG. 4 is a diagram of a fluid propulsion system 401, according to an embodiment. The fluid propulsion system 401, includes a tube 102 having an inlet end 104, an output end 106, and an inner wall including at least a portion 108 that is hydrophilic; and a mount 402 coupled to the tube 102 and configured to operatively couple to a propelled vessel 404. The hydrophilic portion 108 of the inner wall is configured to form an exclusion zone in fluid 406 in the tube, the exclusion zone providing a propulsive force 408 to reactively drive the propelled vessel 404 through a polar fluid 406.

The tube mount 402 may be configured to couple directly to a hull or body of the propelled vessel 404. For example, the propelled vessel 404 may be a boat, a submarine, a pool or spa skimmer, or an icebreaker.

The tube 102 may operate substantially as described for the tube of the fluid flow generator described in FIGS. 1, 2A, 2B, and 3, wherein the fluid flow 408 acts as a thrust and wherein the propelled vessel 404 is propelled 410 reactive to the thrust 408. The fluid propulsion system 401 may include a plurality of tubes (not shown), and the mount 402 may be configured to operatively couple the plurality of tubes to the propelled vessel 404.

In one embodiment, the tubes 102 are coupled to the hull along the sides of the propelled vessel 404, as illustrated. In other embodiments, the tubes 102 may be situated beneath the propelled vessel 404, behind the propelled vessel 404, or in front of the propelled vessel 404. Tubes may be controlled as described above, in conjunction with the fluid flow generator 101. Flow directionality is established in a number of ways. In one embodiment, tapering of the tubes sets the flow direction. In another embodiment flow direction is established by setting up a hydrophilicity gradient along each tube. In yet another embodiment, a small auxiliary pump could set the flow direction.

Flow rate may be highest when exposure to incident electromagnetic radiation is highest. Thus, higher speed may be obtainable by raising the tubes closer to the water surface, where they may receive relatively more radiation. Flow rate can also be regulated by raising the flow engine so that a fraction of tubes are out of the water, or by regulating the closing/opening of a fraction of the tubes with lids or valves (not shown). Alternatively, the vessel 404 may include conventional power, sail, oar, or paddle driven propulsion. The hull of the vessel 404 may include a hydrophilic coating configured to provide additional propulsion to the vessel 404.

FIG. 5 is a diagram of an EZ mixer 501, according to an embodiment. A body 502 having a hydrophilic surface 508 may be at least partially submerged in a polar fluid 504. The polar fluid 504 may be held by a fluid reservoir 506. The hydrophilic surface 508 forms an exclusion zone in the polar fluid 504 in the reservoir 506. The exclusion zone provides a propulsive force to drive fluid flow 510 along the hydrophilic surface 508. Alternatively or additionally, the fluid reservoir 506 may be configured with one or more hydrophilic surfaces such as hydrophilic walls (not shown). Mixing of components to achieve uniformity ordinarily requires energy. With the various flow mechanisms described herein, mixing is achievable automatically by hydrophilic surfaces throughout the volume. In one embodiment the surfaces can be hydrophilic tube sections scattered throughout in various spatial arrangements. In another embodiment the hydrophilic surfaces can be vertically oriented slabs, straight or curved. Such arrangements can be used to create flow and thereby facilitate mixing.

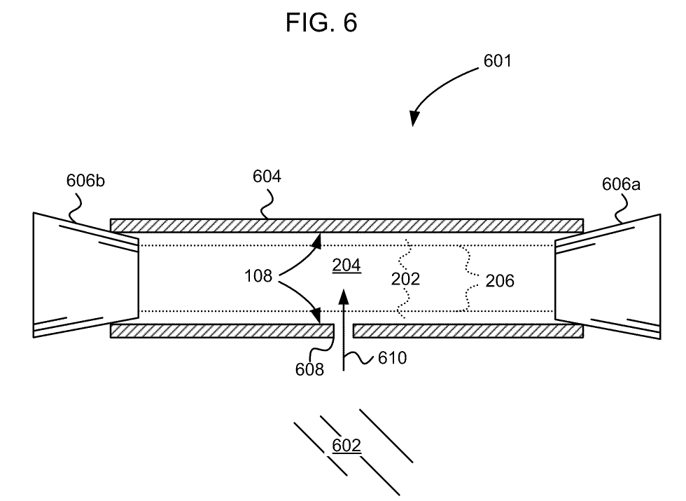

When fluid from a large volume needs to be mixed with fluid in a small container, a method involving a wall penetration may be used as shown in FIG. 6. By implementing such approaches, mixing is achievable with no external energy source other than that from the environment.

FIG. 6 is a diagram of a system 601 for drawing fluid 602 into a tank 604 using the EZ flow effect, according to an embodiment. A tank or cylinder 604, here shown embodied as a tube having stoppers 606a, 606b in its ends, has a hydrophilic inner surface 108. The tank may be filled with a polar fluid. As described above, the hydrophilic inner surface 108 of the tank 604 builds an EZ 202 proximate the hydrophilic surface. The EZ 202 extends from the hydrophilic surface 108 some distance to an interface 206 with bulk fluid 204.

A fluid passage 608 is provided through a wall of the tank 604. A polar fluid 602 is provided outside of the wall of the tank 604 in the vicinity of the fluid passage 608. In FIG. 6, this is indicated as the tank 604 being immersed in the polar fluid 602. The hydrophilic surface 108 applies an exclusion zone 202 to polar fluid in the tank, the exclusion zone 202 providing a propulsive force to pull more of the polar fluid via a fluid flow 610 into the tank. For example, the walls of the tank 604 may be elastic. In this case, the incoming polar fluid 602 increases the pressure and/or the volume inside the tank 604 by expanding the elastic walls of the tank 604.

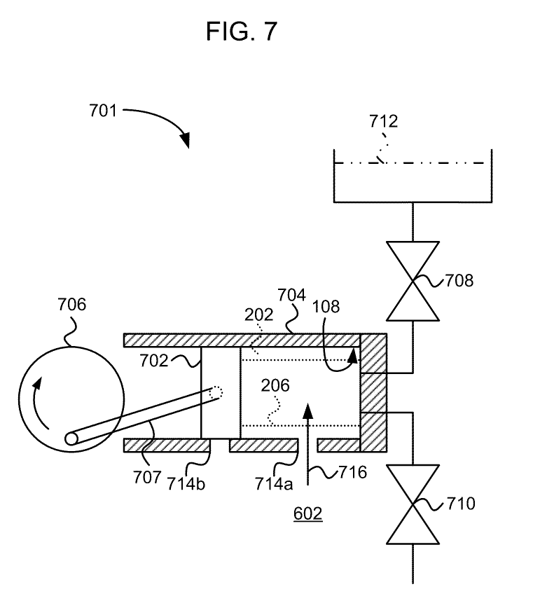

FIG. 7 is a diagram of a piston engine configured to be driven by an EZ-induced flow effect, according to an embodiment. With reference to FIG. 6, rather than expanding elastic walls or pushing out a stopper 606, the incoming fluid may be used to push a piston 702 inside a cylinder 704 formed with hydrophilic walls 108. An opposing cylinder (not shown) may be formed to push in an opposing direction, or alternatively, the opposing end of the cylinder 704 may be plugged and increasing pressure inside the cylinder 704 may push a single piston 702. The piston 702 may be coupled to a crank 706 via a connecting rod 707. The crank 706 may drive a mechanical load (not shown) such as power generation equipment or other energy consuming apparatus. A plurality (not shown) of pistons 702 may be coupled to the crank 706. One or more pistons 702 may be configured to cooperate with the EZ drive mechanism and valves 708, 710, 714 to provide substantially continuous torque responsive to EZ forces in a corresponding plurality (not shown) of cylinders 704. Alternatively, torque may be applied to the crank 706 intermittently, for example to hold the piston 702 in a constant position during an intake phase of a power cycle.

One or more fluid exchange valves, which may include an inlet valve 708 and an outlet valve 710 may be timed to admit a solute-containing polar fluid 712 upon which the hydrophilic surface 108 of the cylinder 704 acts to form an EZ 202. During an intake phase, the cylinder may be at substantially constant pressure and minimum volume. The solute-containing fluid 712 flows in through the fluid inlet valve 708 to replace remaining output fluid, which is expelled through the fluid outlet valve 710. The one or more exchange valves 708, 710 are closed after the fluid has been exchanged.

An EZ 202 forms inside the cylinder 704. Upon formation of the EZ, one or more drive valves 714 opens to admit solute containing drive fluid to the EZ in the cylinder. As described above, the EZ provides a propulsive force (actually an impulsive force) to pull the drive fluid into the cylinder 704. The inflow 716 of solute-containing drive fluid 602 drives the piston 702 to expand the volume inside the cylinder 704. Optionally, the drive valve may include a plurality of fluid inlet passages 714a, 714b configured to sequentially open as the volume of fluid in the cylinder 704 expands during the piston 702 stroke. At the end of the piston stroke, one or more drive valves 714a, 714b may be closed, and the exit valve 710 (which may be combined with the inlet valve 708) is opened to allow the fluid to escape while the piston returns to the minimum volume position. The cycle is then repeated. The cycle may provide unidirectional or reciprocating rotation of the crank 706.

FIG. 8 is a diagram of a multi-stage fluid pump 801 based on principles disclosed herein, according to an embodiment. Referring again to FIGS. 2A, 2B, for example, a nominal fluid transmission distance may span a single tube 102. Alternatively, the nominal fluid transmission distance may be split into a plurality of stages, each stage configured to transmit the fluid a portion of a transport distance. FIG. 8 illustrates a plurality of stages or portions of stages 802a, 802b, 802c. Each stage 802 includes a corresponding transport tube 102a, 102b, 102c configured to transport a polar fluid responsive to an EZ 202 taper as shown in FIG. 2B. One or more intermediate reservoirs 804a, 804b, 804c receive fluid from a corresponding transport tube 102a, 102b, 102c. The transport tubes 102a, 102b, 102c are configured to provide the fluid to the receiving intermediate reservoir 804a, 804b, 804c across an antisiphon valve 806a, 806b, 806c, which may be formed as an air gap (as shown), a low back-pressure valve, or other apparatus configured to prevent hydrostatic communication between an inlet 104(1) of a first transport tube 102(1) and an output 106n of a last transport tube 102n. Thus, in the case of a vertical stack, each stage only needs to provide EZ taper pumping against the hydrostatic height of the individual stage transport tube (e.g. 102b); or in the case of a horizontal stack, each stage only needs to overcome frictional losses corresponding to the total length of each transport tube.

The length of each transport tube 102 and each stage 802 may be selected according to a desired EZ slope 206 (FIG. 2B). A larger EZ slope provides greater pumping power, and therefore a higher flow rate. Each transport tube 102a, 102b, etc. empties into a corresponding intermediate reservoir 802a, 802b. A next transport tube 102b, 102c then pulls the fluid from respective intermediate reservoirs 802a, 802b and pumps the fluid, via the EZ flow method described herein, to the next intermediate reservoir in sequence. Accordingly, a sequence of stages 802(1), . . . , 802a, 802b, 802c, . . . , 802n can raise a polar fluid from a first elevation 820 to a second elevation 822 higher than the first elevation 820.

Referring to FIG. 3, the flow direction of the transport tubes 102 must be established 306, which in turn determines the direction of the EZ taper 308 needed to generate flow 310. The process 306, 308 may be thought of as priming a pump. Similarly, referring back to FIG. 8, the multistage fluid pump 801 is primed to initiate flow. For example, each stage may include one or more vents 808a, 808b formed in a structural tube 810. A priming valve tube 812 may be located circumferential to the structural tube 810 with a lubricant or lubricating interface disposed between the structural tube 810 and the priming valve tube 812. In an initial configuration, the priming valve tube 812 is rotated such that structural tube vents 808a, 808b are misaligned with corresponding vents 814a, 814b in the priming valve tube 812 (configuration not shown). Airspace 816a, 816b, 816c above the nominal surface 818a, 818b, 818c of the respective intermediate reservoirs 802a, 802b, 802c is filled with priming fluid (which may be substantially the same as the fluid to be pumped), which, because the vents 808a, 814a; 808b, 814b; and 808c, 814c are closed, causes the first stage inlet 104(1) to be in hydrostatic communication with the last stage outlet 106n. Accordingly, because the polar fluid is substantially incompressible, a suction pump (not shown) temporarily attached to the last stage outlet 106n can pull fluid through the entire multistage pump 801. After a period of external pumping, the EZs in each transport tube 102(1), . . . , 102a, 102b, 102c, , 102n establish a direction of taper corresponding to upward flow. Upon establishing the flow direction, the priming valve tube 812 is rotated to align the vents 808a, 814a; 808b, 814b; 808c, 814c to allow the airspaces 816a, 816b, 816c to empty to the nominal reservoir surface 818a, 818b, 818c. Optionally, the priming tube vents 814a, 814b, 814c may be positioned and/or elongated to provide sequential opening of the structural tube vents 808a, 808b, 808c for example from bottom to top in order to gradually release each stage 802(1), . . . 802a, 802b, 802c, . . . 802n from bottom to top from suction (priming) pumping to EZ taper pumping, while supporting hydrostatic head with the suction pump (not shown) from the top.

The multistage fluid pump 801 may thus be lowered to operate as a sump pump, bilge pump, or well pump without providing any active pump at the bottom of the sump, bilge, or well. If prime is lost, the priming tube may be rotated to sequentially close the vents 808 from top to bottom while the polar fluid is pumped down from the top. The priming sequence may then be repeated. Optionally, the multistage fluid pump 801 may be preemptively pumped downward from the top, then re-primed at intervals selected to stop build-up or clean scale or other impurities from the hydrophilic surfaces of the transport tubes 102(1), . . . , 102a, 102b, 102c, . . . , 102n and/or other components.

The fluid flow method and apparatuses described herein may be used for a variety of purposes. As shown above, the flow may be used to move fluid, to reactively power a watercraft or the like, to mix a fluid, to expand against a pressurized volume, or to power a piston engine. The movement of fluid may also be harnessed to generate power. Such power generation may include or be in addition to or instead of driving electric current using the charge separation effect described above.

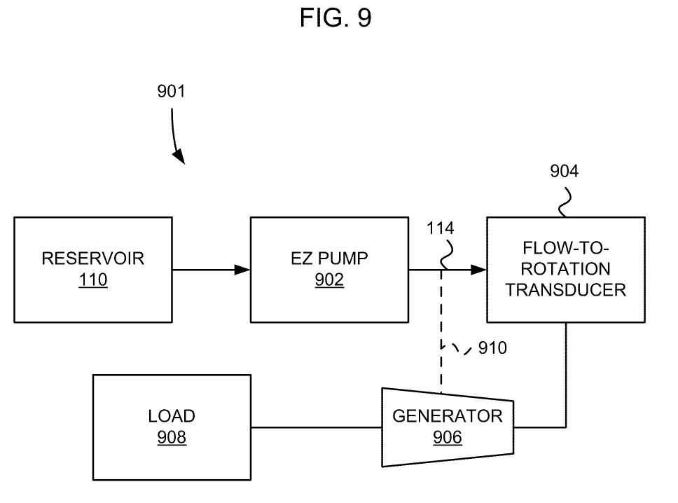

FIG. 9 is a block diagram showing a system 901 for generating electric power from EZ-driven fluid flow, according to an embodiment. An EZ pump 902 pumps fluid from a reservoir 110 to create a fluid flow 114. For example, the EZ pump 902 may be configured as one or more transport tubes 102 (FIGS. 1, 2A, 2B, 8), as a fluid mixing arrangement 501 (FIG. 5), as a fluid pressurizing system 602 (FIG. 6), or as a fluid drive valve 714 and cylinder 704 (FIG. 7). The fluid flow may optionally drive a fluid motion to mechanical motion transducer 904. For example, the transducer 904 may include a piston 702, rod 707, and crankshaft 706 as shown in FIG. 7. The transducer 904 may alternatively include a turbine or other arrangement configured to transfer energy from the fluid flow to mechanical energy. The fluid motion to mechanical motion transducer 904 may couple to a mechanical motion to electrical pressure apparatus 906 such as a generator or alternator, etc. The mechanical motion to electrical pressure apparatus 906 may drive a load or storage device 908 that may, for example, be directly coupled to the apparatus 906 as a dedicated load, or which may alternatively include a power grid.

In an alternative embodiment, the transducer 904 may be omitted, and the fluid flow 114 may operatively couple 910 to the electrical pressure apparatus 906. For example, the electrical pressure apparatus 906 may include an electro-hydro-dynamic (EHD) transducer that generates current flow responsive to a magnetic field produced by the moving fluid. Alternatively, the electrical pressure apparatus 906 may include electrodes configured to couple to the potential difference between the EZ and bulk fluid described above.

The pumping effect of an EZ has been measured in several experiments, some of which are presented in examples below.

### EXAMPLES

### Example 1

### Sample Preparation

The hydrophilic substances used in the experiments included Nafion tubing (TT-050 with 0.042 in. diameter, Perma Pure LLC) and Nafion 117 per-fluorinated membrane (0.007 in. thick, Aldrich). Before use, they were immersed in deionized water for 10 min. All experiments were carried out at 22-23° C. and in a dark room to minimize background noise.

All experiments used deionized water, which was obtained from a NANOpure® Diamond™ ultrapure water system. The purity of water from this system is certified by a resistivity value up to 18.2 mΩ-cm, which exceeds ASTM, CAP and NCCLS Type I water requirements. In addition, the deionized water was passed through a 0.2-micron hollow fiber filter for ensuring bacteria- and particle-free water.

Polybead carboxylate microspheres (2.65% solids-latex, Polysciences Inc.), hydrophilic silica microspheres (SiO2, Polysciences Inc.), and sulfate microspheres (2.65% solids-latex, Polysciences Inc.) were used to delineate the extent of the exclusion zone. The volume fractions of these aqueous microsphere suspensions were set to 1 to 500.

### Experimental Setup

A Zeiss Axiovert-35 microscope was used for all observations. A high-resolution single chip color digital camera (CFW-1310C), well suited for bright-field and low-light color video microscopy, as well as for photo documentation was used for color imaging. It has a pixel resolution of 1360×1024 with a dynamic range of 10 bits. The CCD sensor of that camera employs the widely used Bayer color-filter arrangement.

Two types of chambers were used. The first was made using a thin cover glass stuck to the bottom of a 1-mm thick cover slide with a 9-mm circular hole in the center; that chamber was used for experiments with Nafion tubing. The second was the same except that the hole was a rectangle of length 3.15 cm×width 1.2 cm×and height 1.5 mm, which was for experiments with Nafion membrane, secured with a “micro-vessel” clip to stand up in the middle of chamber (0.75×4-mm jaws, World Precision Instruments).

### Light Source and Incident Power Measurement

For sample illumination a series of LEDs were used. Infrared LEDs (Gistopics) came in TO-18 packages with parabolic reflectors for reducing beam-divergence angle. For the visible range, LED φ5 series (Nichia) was used. And, for illumination in the UV region we used LED NSHU590 (Nichia) emitting at 365 nm, and LEDs UVTOP® 265 and UVTOP® 295 (Sensor Electronic Technology) encapsulated in metal-glass TO-39 packages with UV-transparent hemispherical lens optical windows, emitting, respectively, at 270 nm and 300 nm. All LEDs were driven at 2 kHz by a Model D-31 LED driver (Gistoptics). Output power was regulated for consistency using a Newport 1815-C optical power meter with Newport 818-UV, 818-SL and 818-IR probes.

To obtain an incident beam of small diameter, a pinhole 50 microns in diameter and 0.25 mm thickness (Edmund Optics) was used. An integrated holder was built to keep the pinhole and LED together as a single unit, the LED positioned as close as possible to the pinhole. In order to maximize incident power, the unit almost touched the chamber's edge.

### Temperature Measurements

To measure the temperature at various points within the chamber, an OMEGAETTE™ datalogger thermometer HH306 with compact transition ground-junction probe (TJC36 series) was used. This is a compact dual-input thermometer whose stainless steel-sheathed probe is small enough (250 μm) to fit within the EZ. Its range extends from −200 to 1370° C.±0.2% and resolution is 0.1° C. The datalogger can store up to 16,000 records at programmed intervals as short as once per second.

### Results

A clue for the source of energy for EZ buildup came after having inadvertently left the experimental chamber on the microscope stage overnight. EZ size had diminished considerably; but after turning the microscope lamp on, EZ size began immediately to increase, restoring itself to the former size within minutes. With preliminary evidence that light could expand the EZ, we investigated systematically whether the energetic source for EZ buildup might indeed be radiant energy.

Water is known to have a strong absorption peak at a wavelength 3.05˜3.10 μm, corresponding to a symmetric OH stretch. Hence, the first used light source used was one with peak output at 3.1 μm, LED31-PR, which has full width at half maximum (FWHM) of 0.55 μm.

Nafion tubing was suffused with a 1-μm carboxylate-microsphere suspension with a 1:500 volume fraction, to a depth of −1 mm. The chamber was made using a thin cover glass stuck to the bottom of a 1-mm thick cover slide with a 9-mm circular hole cut in the center, and was placed on the stage of the microscope. A pinhole was used to obtain an incident beam of restricted diameter. A fabricated holder integrated the pinhole and LED into a single unit with the LED mounted close to the pinhole. The LED-pinhole axis was vertically oriented.

### Basic Observations

After the EZ had grown to a stable size, usually within 5 minutes, the incident radiation was turned on. Optical power output was 33 μW, and the estimated power received through the pinhole was ˜2.4 nW. After five minutes, the LED assembly was removed and the EZ was immediately photographed through the microscope. It was apparent that even with modest IR exposure, the EZ grew to approximately three times its control size.

We also tracked the time course of EZ-width increase. This was carried out not only with the 3.1-μm source, but also with the 2.0-μm and 1.75-μm sources (FWHM=0.16 μm and 0.18 μm, respectively). For the latter two sources, intensities were maintained at approximately 190 μW; but for the 3.1-μm source, power was kept at the maximally attainable value, 33 μW.

During a 10 minute exposure at all three wavelengths, EZs continued to expand approximately linearly. The largest effect was seen at 3.1 μm, despite lower incident power. To determine whether the EZ continues to expand beyond the 10-min exposure, the 3.1-μm source was left on at the same intensity as above for up to one hour. The ratios increased from 3.7±0.10 (10 min) to 4.7±0.12 (30 min) and to 6.1±0.17 (1 hr) respectively. Hence, the EZ continues to expand with continued exposure for up to at least one hour. Longer durations were deemed unreliable, as evaporation became noticeable; hence measurements were suspended.

Post-illumination EZ-size dynamics were examined as well. When the infrared light was turned off after 5-minutes exposure, EZ width remained roughly constant with fluctuations for about 30 min; then, it began decreasing noticeably, reaching halfway to baseline levels in typically ˜15 minutes.

To determine the effect of beam intensity on EZ expansion, the 2-μm source was employed at three power levels, 0.21, 0.34, and 1.20 mW. The rate of EZ expansion increased with an increase of incident power.

EZ expansion is a function of both time and intensity. Hence, EZ growth depends on the cumulative amount of incident energy induced charge separation.

To test whether the expansion might arise out of some unanticipated interaction between the incident radiation and the particular type of microsphere probe, microspheres of different size and composition were tested. For carboxylate microspheres of diameters 0.5 μm, 1 μm, 2 μm, and 4.5 μm at the same volume concentrations (1:500), mean expansion ratios for 5-min exposure of 3.1-μm radiation were: 2.41, 2.97, 3.08, and 3.34, respectively (n=6). For 1-μm microspheres made of carboxylate, sulfate, and silica under conditions the same as above, expansion ratios were 2.97, 3.10 and 1.50 Hence, some material-based and size-based variations are noted—the latter arising possibly because of different numbers of particles per unit volume; but, appreciable radiation-induced expansion was nevertheless seen under all circumstances and with all materials. Hence, the existence of the light-induced expansion effect is not material specific.

### Spatial Illumination Effects

We also explored the effect of illuminating with IR at different positions relative to the Nafion/water interface. For these measurements, a sheet of Nafion 117 film, approximately 6 mm long and 1.5 mm high, was held by a micro-clip and positioned in the vertical plane near the middle of the chamber. The chamber was made from a rectangular glass block, length 7 cm, width 2.5 cm and height 1.5 mm, with a rectangular hole, length 3.15 cm and width 1.2 cm, cut through from top to bottom and a 1-mm-thick glass slide sealing from beneath. The film's upper edge was level with the solution surface. The vertical scale was carefully calibrated using a 1-mm-thick glass slide with face markings; one millimeter corresponded to 634 divisions on the focus knob. A 50-μm pinhole was placed immediately above the specimen in order to restrict incident spot size. To estimate spot diameter at different solution depths, a visible source (microscope light with green filter, λ=550 nm) was substituted for the LED. Beam diameters increased approximately linearly from 160 μm at the solution surface, to 240 μm at 1.5 mm below the surface. (These values are only approximate, as diameters will change with wavelength.) For observation and data-collection periods, which necessitated some illumination, intensity was minimized by use of this same filter.

When the beam was first positioned in the middle of the EZ, we measured the expansion ratios at different depths. Maximum expansion occurred at a depth of approximately 450 μm from the solution surface, and was detectable well beyond 1 mm. The fact that the maximum expansion occurred well below the surface is unusual given the limited IR penetration ordinarily expected in water. One possibility is that penetration through the EZ is deeper than through bulk water: EZ-like zones are found at the air-water interface, and if IR radiation does penetrate more deeply through such zones, then the unexpectedly deep effects might be explainable. Indeed, changes in IR-absorption depth are noted in confined geometries, where interfacial, or EZ-like, water is abundant; hence, EZ water may have longer penetration depth than bulk water. Alternatively, the unexpectedly deep effects could arise indirectly: e.g., incident radiation creating ions, free radicals, or other highly reactive entities in the bulk, which are then free to diffuse in all directions, enhancing the downward EZ buildup.

With the same setup as above, the spot was then positioned at varying distances from the Nafion-water interface. Expansion was largest when light was focused in the center of the EZ, and fell off on either side, although not appreciably. At deeper positions, the near-Nafion expansion peak tended to broaden somewhat, possibly because, of incident-beam broadening; but, the trend was essentially similar at all depths. The most notable finding is that even when the beam was positioned far from the Nafion surface, the expansion effect was appreciable.

### Controls for Temperature

Infrared absorption in water causes a temperature elevation. Hence, we considered the possibility that the expansion might arise from an appreciable increase of chamber temperature. To measure local temperatures, an OMEGAETTE™ datalogger thermometer HH306 was used, with stainless-steel-sheathed, compact transition ground-junction probe (TJC36 series), small enough (250 μm) to fit within the EZ. With the incident beam positioned to elicit the maximum expansion, i.e., centered 175 μm from the Nafion surface, the measured temperature increases are shown in Table 1. Radiation-induced temperature increases were modest at all positions and fairly uniform over the chamber. We also found little temperature variation with depth, implying that the thermal mass of the probe itself, immersed by varying extents for measurements at varying depths, did not introduce any serious artifact.

TABLE 1
Temperature increases measured at different distances
from the Nafion surface after 10 min. exposure to
3.1-μm radiation (n = 3)

| | Mean |
|---|---|
| Distance from | temperature |
| Nafion | increase |
| 175 μm | 1.1° C. |
| 250 μm | 0.91° C. |
| 350 μm | 0.92° C. |
| 4 mm | 0.91° C. |
| 6 mm | 0.92° C. |

Further to this point, we recorded the dynamics of temperature rise. The temperature increase occurred steadily, reaching a plateau of −1° C. at 10-15 min after turn-on. This plateau was attained at a time that the EZ continued to expand. Hence, not only was the temperature increase modest, but also the time course of temperature rise and EZ expansion were not correlated.

### Spectral Analysis

A principal objective was to determine EZ-expansion's spectral sensitivity. The experimental setup was similar to that described above. The ˜200-μm wide light beam emerging from the pinhole was directed to the middle of EZ, and expansion was measured 300 μm below solution surface. For the UV and visible sources, maintaining consistent optical power output at all wavelengths was achievable within +/−10% by adjusting the driver current. But IR sources were considerably weaker; hence output power was maintained at a lower level, three orders of magnitude lower than in the UV-visible ranges. Spectral results are therefore plotted separately.

For UV and visible ranges all incident wavelengths brought appreciable expansion. The degree of expansion increased with increasing wavelength, the exception being the data point at 270 nm, which was higher than the local minimum at 300 nm. The higher absorption may reflect the signature absorption peak at 270 nm characteristic of the EZ. Clear wavelength sensitivity was also found in the IR region, the most profound expansion occurring at 3.1 μm. Recognizing that the optical power available for use in the IR region was 1/600 of that in the visible and UV regions, one can assume that with comparable power, the IR curve would shift considerably upward. Hence, the most profound effect is in the IR region, particularly at 3.1 μm.

For building the EZ, incident IR must induce some change in bulk water, the most likely manifestation of which is molecular dissociation. It is already established that next to anionic surfaces the EZ is negatively charged. We observed evidence that negative charge buildup next to Nafion is associated with proton buildup in the bulk water beyond. Whereas the EZ is negatively charged, the region beyond the EZ appears to be positively charged. In other words, incident electromagnetic energy appears to split water into negative and positive moieties, creating potential energy.

### Discussion

The most significant result of this study is that the near-surface exclusion zone expands extensively in the presence of radiant energy. That is, growth of this more ordered, negatively charged zone is dependent on incident electromagnetic energy.

The overall spectral sensitivity of expansion follows closely the spectral sensitivity of water absorption. In both cases, there was an overall minimum in the near-UV, plus a local maximum at 2.0 μm, and a peak at 3.1 μm. If not by coincidence, then a connection is implied between IR absorption and EZ expansion—although the linkage is apparently not through temperature increase, which was both modest and temporally uncorrelated. Further to this point, increasing the bath temperature actually diminishes EZ size (unpublished observations). Hence, the effect of incident electromagnetic energy is apparently non-thermal.

### Mechanistic Considerations

A question is how radiant energy could augment EZ size. This question rests on the more basic question of the energy responsible for the original EZ buildup, for buildup and augmentation may be driven from the same energetic source. Since infrared energy is consistently available under non-extreme conditions, IR energy is likely to be the agent responsible for both the initial buildup and the augmentation.

To build the EZ, bulk water must undergo some kind of change. We found that as the negatively charged EZ builds, the concentration of protons in the region beyond the EZ likewise builds. Two independent techniques confirm this. Indeed, electrodes placed in the respective zones are able to deliver substantial current to a load, confirming genuine charge separation between the EZ and the bulk-water region beyond.

Hence, it appears that the mechanism involves radiant energy-induced splitting of bulk water into negative and positive entities. The negative entity forms the ordered EZ, while the positive entity distributes itself broadly over the bulk. The negative-positive combination forms a battery-like entity, fueled by radiant energy.

While the energy of an IR photon is generally considered too low to split water, some dissociation of water occurs even in the absence of external energy sources; i.e., the dissociation constant of water, Kw=[H+][OH—], underlies all pH measurement, and presumes that there is some dissociation even under ambient conditions. Incident IR would merely augment the naturally occurring dissociation. Once dissociated—either under natural IR exposure or augmented IR—the negative component would then go on to form the more ordered EZ. IR-induced ordering of water is not a new result; such ordering has been reported previously. Hence, there is precedent for this kind of IR-induced ordering.

Classical thermodynamics prohibits splitting of water by IR because the energy required to break a partially covalent hydrogen bond is greater than energy of an IR photon. On the other hand, quantum considerations suggest that infrared radiation, between 3 μm and 14 μm, has strong resonant effects on OH stretch, thereby resonantly raising the system's vibrational energy. Of those wavelengths, 3.1 μm, or wavenumber approximately 3200 μcm⁻¹, corresponds to the symmetric OH stretching of tetrahedrally coordinated, i.e., strongly hydrogen-bonded, “ice-like” water; hence, interfacial water has a more localized peak at 3200 cm⁻¹ than does bulk water. Further, incident IR results in experimentally confirmed frequency-selective resonant photo-dissociation of the hydrogen-bond network. Apparently, such resonant irradiation induces multiphoton excitation of water molecules, which reorganizes the large hydrogen-bonded network into smaller ion-pair-state (H+ . . . OH—) water clusters with increased mobility. Thus, the IR-induced dissociation of water implied here has both precedent and physical rationale.

### Example 2

### Experimental Methods

The experimental chamber was made of a 2-mm thick rectangular plastic block with a vertically oriented 1-cm diameter cylindrical hole cut in the middle. The bottom of the hole was sealed with a No. 1 glass microscope cover slip (150 μm thick), through which the sample could be observed. Prior to each experiment all surfaces were cleaned thoroughly with ethanol and de-ionized water.

The suspensions under study consisted of three components: a single ion-exchange-resin bead (Bio-Rex MSZ 501(D) resin), microspheres, and distilled, de-ionized water. The ion-exchange-resin beads used were 600±100 μm in diameter and came in two types: anionic and cationic. Only one bead was used in each experiment, either positively charged or negatively charged. Prior to use, beads were washed with ethanol, and then washed again several times with de-ionized water from a Barnstead D3750 Nanopure Diamond purification system (type I HPLC grade (18.2 MΩ) 2 μm, polished).

The microspheres used in this study were principally surfactant-free sulfate, white, polystyrene-latex, 2 μm in diameter (product number 1-2000, Interfacial Dynamics Corporation, Portland, Oreg.). Particles of this size undergo vigorous Brownian motion in water, and are sufficiently large to be imaged with a conventional light microscope. The microspheres are synthesized with a large number of sulfate groups chemically bound to their surfaces. These groups dissociate in water, each having a single negative charge bound to the microsphere surface and giving a compensating positively charged counter ion in solution. Therefore, the sulfate microspheres used in experiments were negatively charged.

All experiments were conducted on a Melles Griot isolation bench to shield against ambient vibration.

We pursued three categories of experiment: (i) one positively charged bead and negatively charged microspheres; (ii) one negatively charged bead and negatively charged microspheres; (iii) controls. For each experiment, a single bead was first placed in the chamber. Then, an aqueous microsphere suspension with a volume fraction of approximately 0.08 was added. Once the bead settled firmly to the bottom, the chamber was sealed carefully with a No. 1 microscope cover slip and put on the sample stage of an inverted Zeiss Axiovert-35 optical microscope, used in the bright-field mode with either a 10×, 5×, or 2.5× objective lens depending on the goal of the particular experiment. An attached color digital camera (Scion Corporation, CFW-1310C) was used to record images and videos. Track* Version 1.0 (© 2001 Penn State University) was used to track the trajectories and coordinates of the microspheres. Radial velocity was then calculated as a function of distance from the bead surface, and the results were plotted.

In the controls, different negatively charged microspheres (2 μm carboxylate, Polysciences, Inc. Cat #18327) were used to test if the attraction might be the consequence of the specific surface-functional group that was ordinarily used. As another control, we replaced the ion-exchange bead with another charged surface, Nafion, to test whether unanticipated ion-exchange action might have caused the attraction. Nafion-117 is composed of a carbon-fluorine backbone with perfluoro side chains containing sulfonic acid groups, fabricated from a copolymer of tetrafluoroethylene and perfluorinated monomers. A 600-μm diameter Nafion grain was used in place of the bead. Third, extremely diluted concentrations of microspheres were used to determine whether the long-range attraction still exists when microsphere-microsphere distance increases sufficiently. We employed the lowest practical concentration (1/200 normal)—one that just barely allowed the required measurements to be made. Finally, some of the experiments were repeated in a chamber made solely from polycarbonate to rule out artifacts due to glass surfaces at top and bottom.

### Results

### Positively Charged Bead and Negatively Charged Microspheres

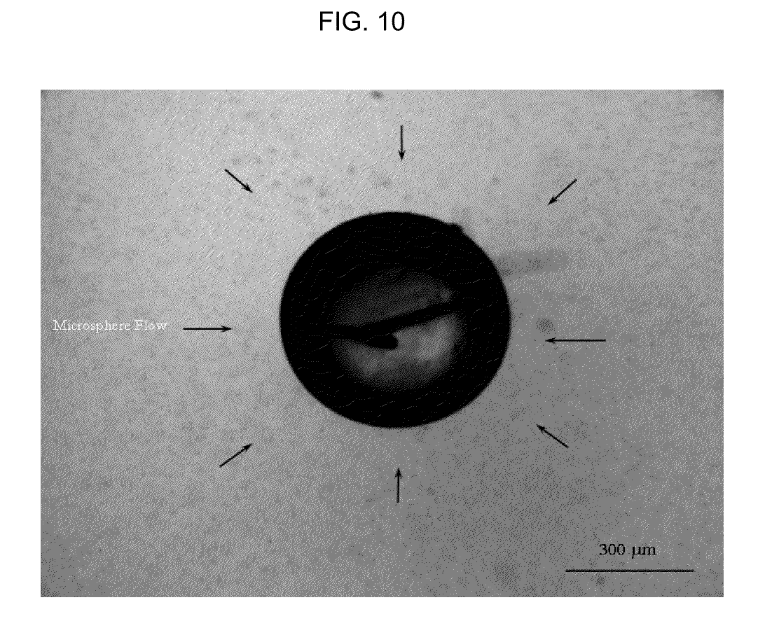

For these experiments, one positively charged bead was placed in a solution of negatively charged microspheres (see FIG. 10). Immediately after the chamber was placed on the microscope stage, microspheres were observed to be moving toward the bead surface from all directions. These movements continued for up to three hours. The motion occurred throughout the chamber towards the bead from all directions, as illustrated by the arrows in FIG. 10. At distances of 200 μm from the bead surface, microspheres moved consistently toward the bead at a speed of about 1 μm/s.

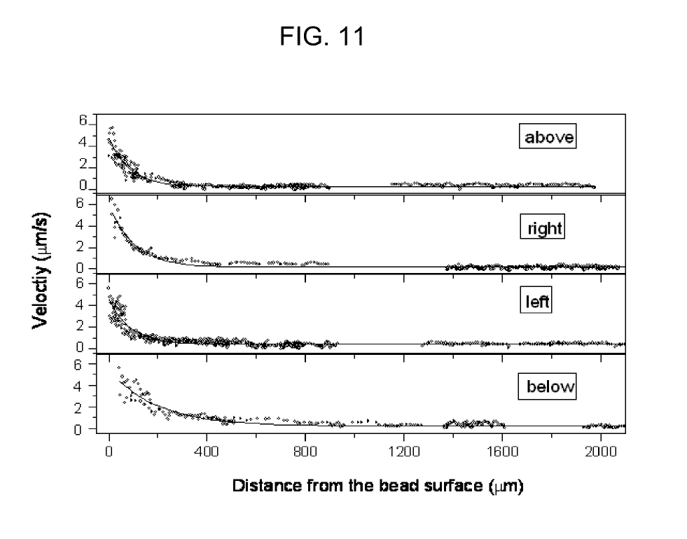

Attractive movements were found even at distances of up to 2 mm from the bead surface (FIG. 11). Data points obtained from four orthogonal directions were assembled into a single figure for comparison. All data were recorded just after the microsphere suspension had been added to the chamber. The resulting velocity-vs.-distance trends are similar in all four curves. At distances farther than 400 μm from the bead surface, velocity remained invariant at a value of ˜0.3 μm/s. At positions closer than ˜200 μm, velocity began to noticeably increase approximately exponentially, up to a value of ˜5 μm/s at the bead surface, implying a distance-dependent attractive force. On the other hand, the fact that microspheres still moved toward the bead at distances of 2,000 μm or farther implies that attractive interactions extend over an extremely long range.

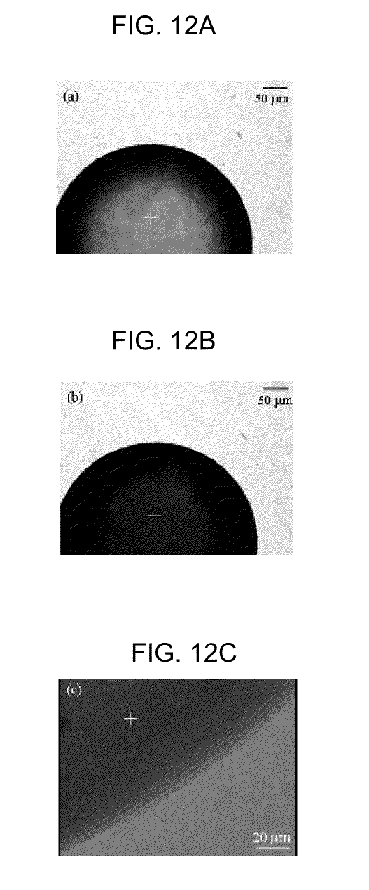

With increasing time, microspheres accumulated progressively at the surface of the bead, and after one hour, a bead-surface cluster could be readily detected (FIGS. 12A-12C). FIG. 12A is the image of the bead surface at the start of the experiment. In FIG. 12B, taken after one hour, the bead surface appears darker because more microspheres had deposited. In order to examine more details of microsphere deposition on the bead surface, smaller microspheres (D: 0.47 μm) were substituted for the 2-μm spheres ordinarily used. The surface structure could then be seen as a colloidal crystal (see FIG. 12C). Possibly, an element of crystallinity was present with the larger microspheres as well, but less conspicuous because of irregularities in layered structure and the presence of fewer layers.

Microsphere movements were tracked in several different focal planes, above, below, or the same as, the bead's equatorial plane. Irrespective of the plane, microspheres behaved similarly—moving toward the bead and moving faster when within 200 μm of the bead surface. Eventually, all microspheres settled on the bead surface.

### Negatively Charged Bead and Negatively Charged Microspheres

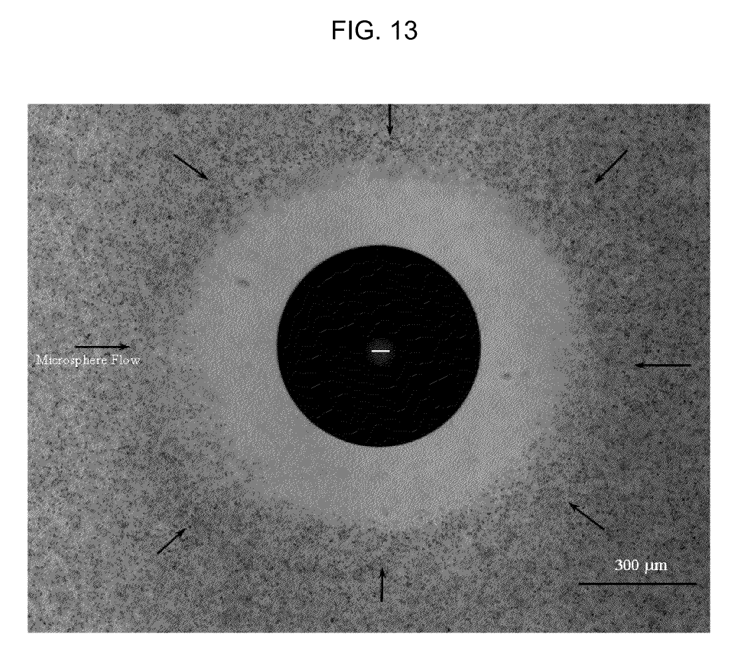

For these experiments one negatively charged bead was used in conjunction with negatively charged microspheres. In contrast to the former setup with the positively charged bead, the negatively charged bead was ultimately surrounded by a clear “exclusion zone” devoid of microspheres (FIG. 13). Such exclusion zones have been reported in detail in earlier work. The exclusion zone first grew with time, and finally became stable after approximately 10 minutes. It extended roughly 300 μm from the bead surface, similar to previous observations.

During the formation of the exclusion zone, microspheres were progressively excluded from the vicinity of the bead, translocating to positions beyond the exclusion zone. Once the exclusion zone was fully established, microspheres became attracted to its far edge from all directions, as illustrated by the arrows in FIG. 13. Such attraction is unexpected, as microspheres and bead have the same (negative) charge polarity.

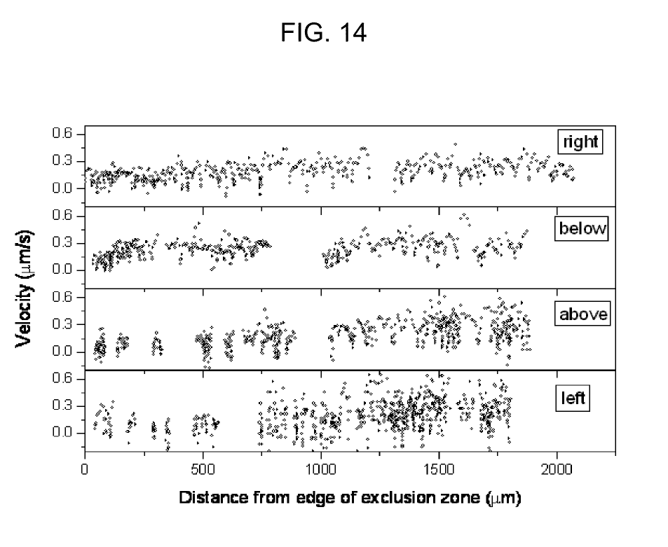

The dependence of velocity on distance from the exclusion-zone edge is shown in FIG. 14. Positive values of velocity imply attraction between negatively charged microspheres and negatively charged bead surface. The figure confirms that microspheres were attracted towards the bead from every direction, and from distances as large as 2 mm from the edge of the exclusion zone. The velocities were lower than in the case with positively charged bead, and remained at more or less the same value of −0.3 μm/s throughout the effective range of up to 2 mm from the exclusion-zone edge (with some diminution close to the exclusion-zone edge; see Discussion), indicating the presence of a long-range attractive force in the direction of the bead, even though the bead and microspheres are of the same charge polarity.

Upon examining different focus planes, we found that as microspheres moved closer to the bead, they also moved toward the lower focal plane. Most of them accumulated on the glass surface at the bottom of the chamber, near the point where the bead touched the floor of the chamber. Immediately above the chamber floor and near to the bead, some microspheres translated away from the bead as others from above moved toward the bead, as though there were some minor circulation within a zone of about 150 μm. For the most part, however, microspheres progressively accumulated at the bottom, near the bead.

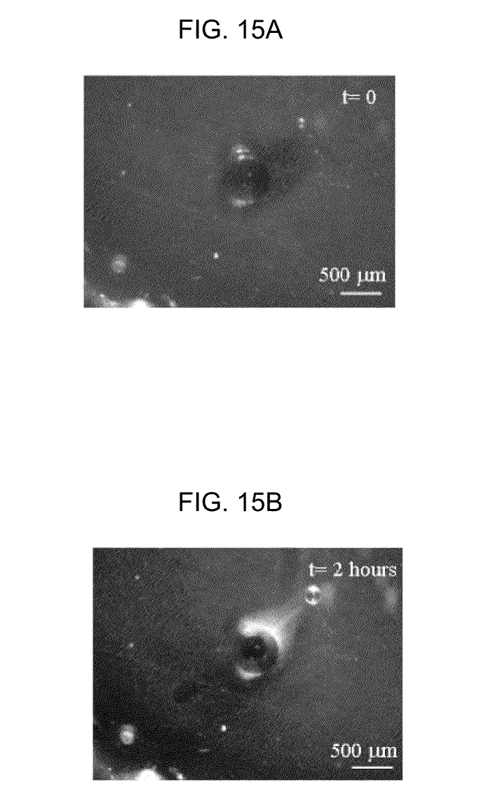

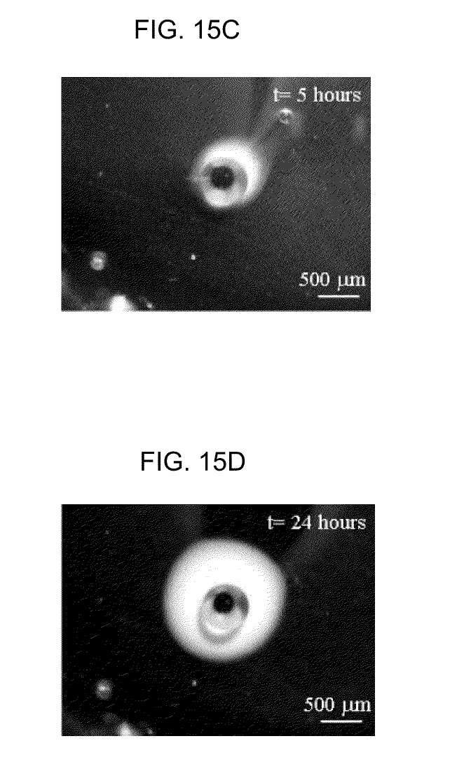

The pictorial time course of accumulation is shown in FIG. 15 with a negatively charged bead sitting at the bottom of the chamber. The pictures were taken at a focal plane lower than bead's equatorial plane. The region of sediment around the bottom of the bead grew with time, as can be seen by the progressive growth of the white area. Furthermore, after 24 hours, the suspension itself appeared much clearer, indicating fewer microspheres remaining in suspension—most of them having already settled at the bottom near the negatively charged bead.

### Controls

We substituted carboxylate microspheres in order to rule out the possibility that the attraction was related to some specific feature of the sulfate microspheres used regularly. The results were similar. The negatively charged carboxylate microspheres were attracted to the negatively charged bead in all planes out to a distance of more than 2 mm from the exclusion-zone edge. Likewise, attraction to the positively charged bead took place at a velocity of 0.3 μm/s when microspheres were farther than 400 μm from the bead surface; and, beginning at a distance of ˜200 μm from the bead surface velocity increased exponentially to a terminal value of 4 μm per second at the bead surface. Hence, in terms of the long-range attraction to both positively and negatively charged beads, carboxylate microspheres behaved in the same way as sulfate microspheres.

We also checked the bead. In order to test for some unanticipated ion-exchange effect of the particular bead material, we substituted a grain of Nafion. Similar to the negatively charged bead, the grain of Nafion also developed an exclusion zone, which grew to 300 μm within 20 min. Measured just after that time, microspheres translated towards the edge of the exclusion zone at a velocity of ˜0.3 μm/s, quantitatively similar to the behavior observed with the negatively charged bead. Hence, the nature of the “attractor” material seemed to play no decisive role.

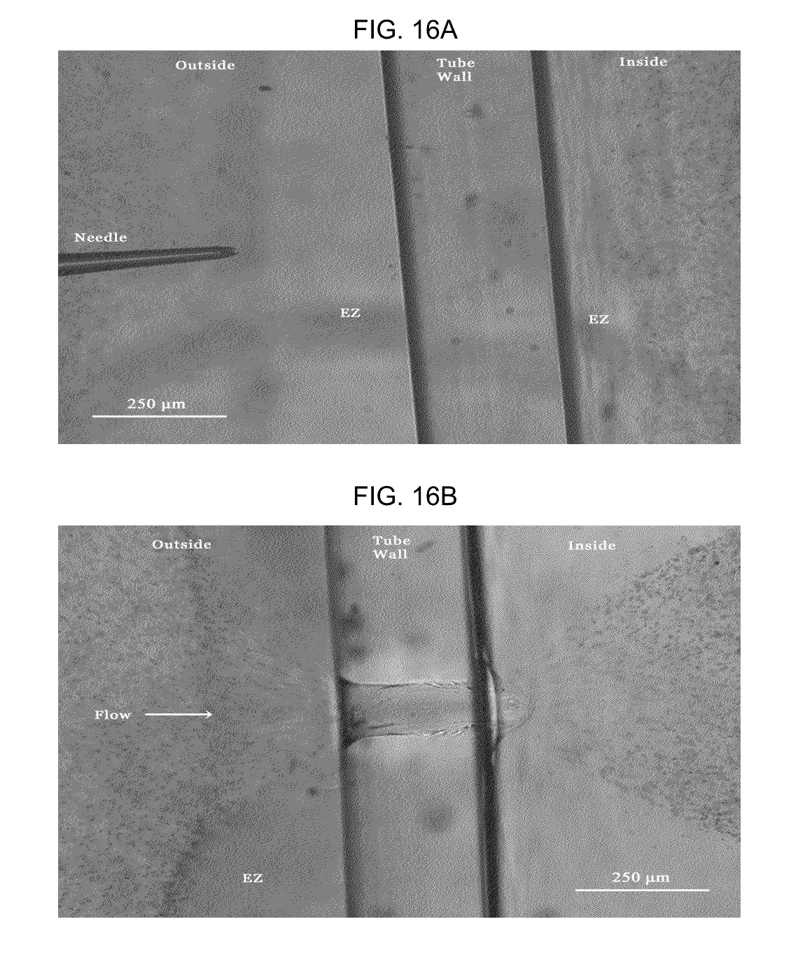

Experiments were also carried out using a reduced concentration of microspheres to see whether long-range attraction still exists when the separation of microspheres is very much increased. At the lowest practical concentration (1/200 normal), the mean distance between adjacent microspheres was ˜200 μm. Surprisingly, long-range attractive behavior persisted. FIGS. 16A and 16B show representative curves of distance vs. velocity respectively around positively and negatively charged beads with reduced microsphere concentration. Positive values of velocity indicate attraction. In both cases, microspheres move toward the bead throughout the 2-mm range. The shapes of these curves are similar to those in FIGS. 11 and 13, respectively, although the velocities are lower and there is considerable scatter. Despite such extreme distances between microspheres, long-range attraction was still evident.

### Example 3

### Methods

A length of 3-mm diameter Nafion tubing (PermaPure TT-110, Toms River N.J.) ˜7 cm long was placed in a plastic chamber 4.5 cm wide, 1.8 cm long, and 6.4 mm deep. The tube laid horizontally in the reservoir, protruding through each of two holes drilled in opposite sides of the chamber wall. Hole diameter was carefully chosen to hold the tube securely but not allow water to escape.

A solution of distilled, deionized water (resistivity of 18.2 MΩ-cm, Barnstead Accu-Dispense) and 2 μm carboxylate microspheres (Polysciences Inc, Warrington Pa.) was prepared using a ratio of 1 drop of microsphere suspension per 15 mL of water. The resulting suspension was mixed until it appeared homogeneous. The Nafion tube was placed into the empty reservoir, with ends protruding through the holes. The solution was then poured to fill the reservoir to a level 1.3 mm above the tube, and a syringe was used to fill the inside of the tube, whose ends were both left open to the air. Both the reservoir and tube were filled from the same microsphere suspension. The reservoir/Nafion-tube system was then set aside for 10-15 minutes to allow the EZ to develop.

For puncturing the tube, a tapered needle was made using a 5-mL, 1.1-mm outer-diameter glass pipette (VWR, West Chester Pa.) and a vertical pipette puller (David Kopf Instruments, Tujunga Calif.). This device heats the glass while pulling apart both ends, resulting in two very fine tapered glass needles (˜0.05 mm diameter at the tip). One of these needles was placed in a micro-manipulator that allowed for fine motion along all axes, and which facilitated the hole puncturing.

After the tube had been immersed in the suspension for 10-15 minutes, a hole was created midway along the length of tube by pushing the needle through the side of the tube wall until it created a hole ˜0.2 mm in diameter. The needle was then slowly retracted, taking care to avoid disturbing the Nafion tube unduly, and leaving the hole open for water to pass through.

Water flow was observed by tracking the suspended microspheres under an inverted microscope (Nikon Diaphot, with Zeiss CP-Achromat magnifier and Leica DFL-290 camera) with 5× objective. We confirmed that liquid was indeed flowing into the tube by observing the continuous movement of the meniscus inside the tube. As the suspension had a relatively uniform microsphere density, the number of microspheres seen passing through the hole from the reservoir into the tube should be directly proportional to the flow volume, which would otherwise be difficult to measure accurately.

### Results

The initial result was the visual observation of a clear and consistent flow of water from the outside of the tube, through the hole, to the inside of the tube. This is shown in FIGS. 16A and 16B. The figures shown are representative of ten experiments each carried out identically as described above.

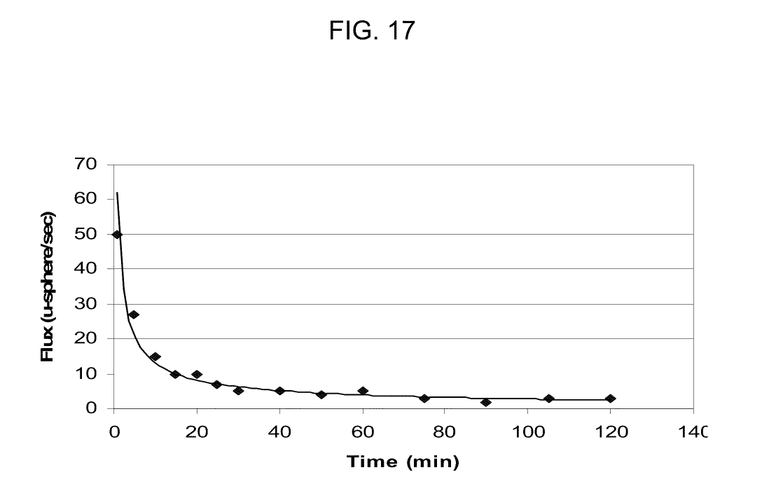

By tracking the inward motion of microspheres through the hole, it was possible to monitor the rate of flow over time. Inward flow started out strong but dropped off to a constant non-zero value after tens of minutes (see FIG. 17). The plateau values varied from experiment to experiment, depending mainly on hole diameter; but mean values obtained from ten experiments were 5.7+/−2.7 microspheres per second.

To test the possibility that only the microspheres, but not the microsphere suspension, were passing through the hole, we examined the menisci position inside the tube as a function of time. There was a clear shift in the menisci at both ends of the tube starting immediately after the hole was opened, indicating that the fluid was indeed flowing through the hole rather than the microspheres alone. Additionally, the shape of the menisci changed from concave initially to flat while fluid was flowing; this implied that it was indeed the fluid's pressure that was pushing the menisci outward.

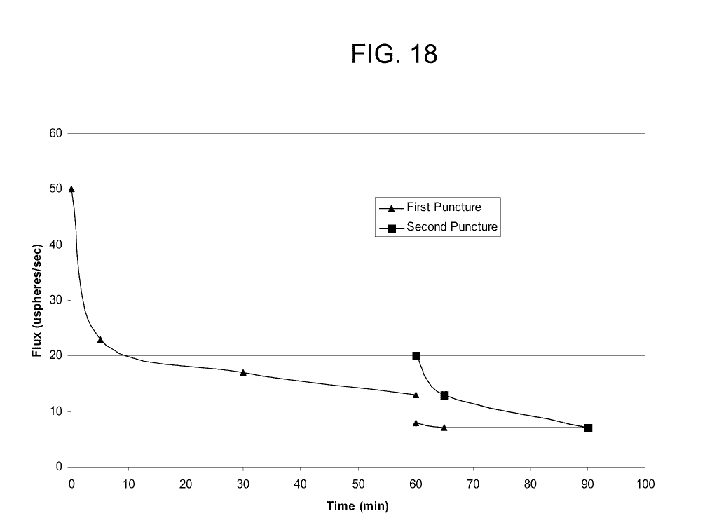

To test whether the underlying mechanism involved local effects only, we created a second hole ˜1 cm from the first. This was done approximately one hour after the first hole was punched. We found that the flows were coupled; i.e., just as the second hole was punched, flow through the first hole abruptly diminished (FIG. 18). Meanwhile, flow through the second hole exceeded the pre-puncture flow through the first hole. Both flows continued to decrease with time. This coupling implied that the flow was dependent both on local properties and characteristics of the tube system in general.

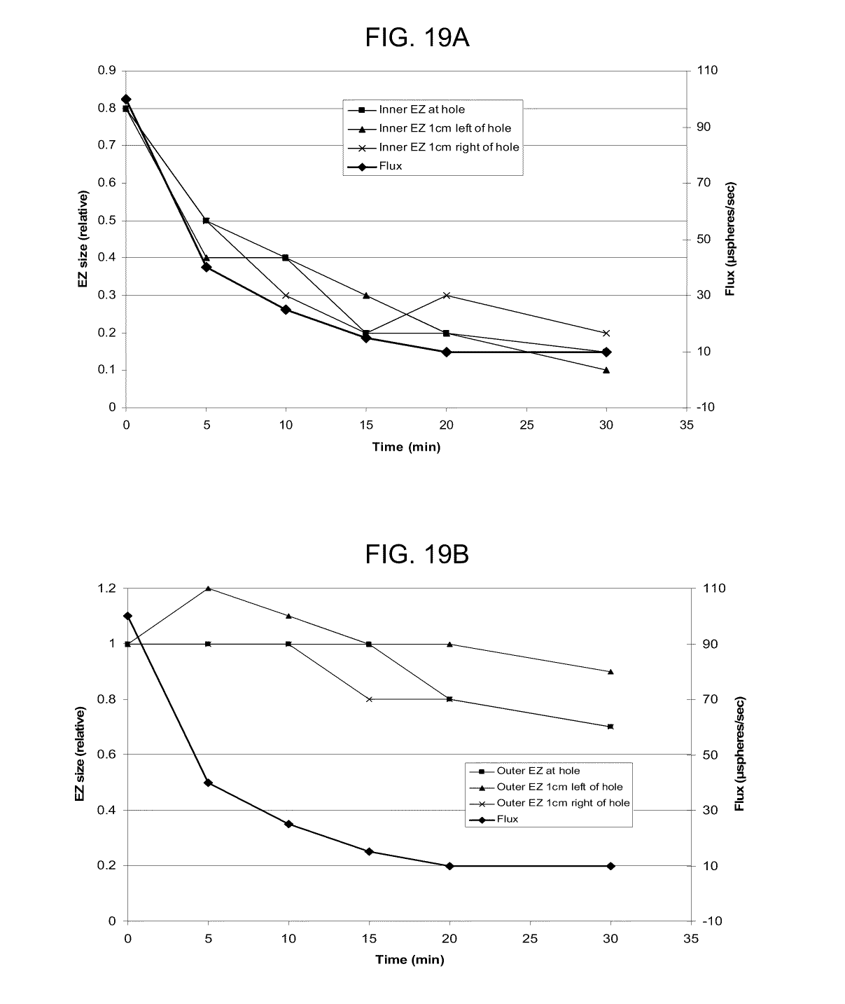

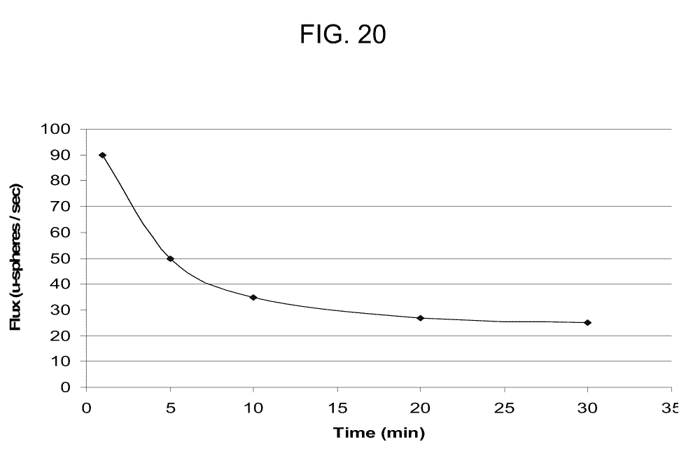

To determine whether EZ size might play a role in determining flow, we tracked inner and outer EZ sizes as a function of time, along with flow rate (FIGS. 19A and 19B). Outer EZ showed little variation with time; however, inner EZ did vary substantially over time: as inner EZ size shrank, flow diminished concomitantly. Representative data are shown in FIGS. 19A and 19B.

To test further for EZ involvement in the phenomenon, a control experiment was carried out using a Tygon tube (Cole-Parmer, Vernon Hills Ill.) which exhibits no EZ. The same procedures were followed as described above, using a tube of similar size and diameter. The needle produced a hole in the tube, but no flow was observed. From these observations and those of FIG. 19A and FIG. 19B we could draw two conclusions: First, the exclusion zone is likely to be a relevant factor for the presence of flow. And second, that gravity-related hydrostatic pressure is not a critical factor, as the depth of the silicon tube was the same as the Nafion tube.

In order to explore further the role of the EZ in this flow, we studied whether flow dynamics might be impacted by induced changes in EZ size. Earlier research had shown the EZ to be negatively charged. Hence, by adding H⁺ in the form of an acid, charge neutralization could reduce EZ size; or, by adding OH⁻ in a base the increased negative charge could enhance EZ size. This expectation proved accurate, and it was thus possible to test the effects of EZ size on flow rate. These tests involved creating acidic or basic suspensions, which were then substituted for the aqueous suspensions inside or outside the tube, giving four different conditions.

With a 0.01M NaOH-containing microsphere suspension introduced into the Nafion tube instead of the control suspension, the inside EZ expanded from ˜0.2 to ˜0.5 mm. When punctured, the inward flow was considerably greater than the control. Instead of dropping to a rate of 4-5 microspheres/second, the flow leveled off at 20-25 microspheres/second (FIG. 17). Hence, increased inside EZ was associated with increased flow.

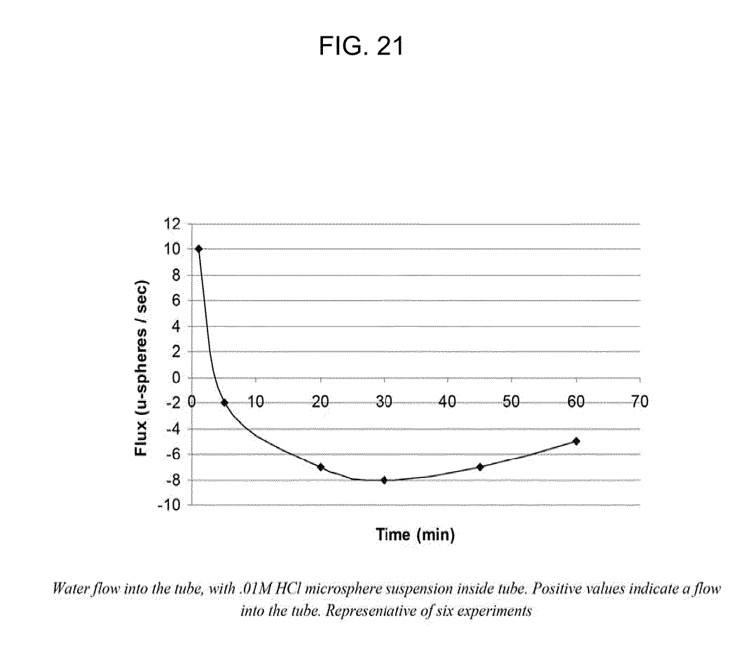

With HCl of the same concentration inside the tube, the inside EZ became almost zero, compared to ˜0.2 mm for the control. The flow began inward as usual, then dropped to zero at the 5 minute mark, and then reversed direction. The outward flow increased over the next half hour, reaching a maximum outward flow rate of 10 microspheres/sec before diminishing to a slower rate (FIG. 21). Similar patterns were seen in each of six experiments, although the dynamics differed slightly.

Acidic and basic solutions were also placed outside of the tube rather than inside. With acid outside the tube, the flow behaved similarly to the NaOH-inside results: inward flow was much higher than the control and remained at a higher steady rate relative to controls after 30-40 minutes. Significant complications were encountered when using NaOH outside the tube. Once the inward flow started, the microspheres began clumping together and precipitating out of the suspension. As a result, no significant data were obtainable for NaOH outside the tube.

For all of these four pH tests, we also tracked inside EZ size, as done with the original tests described above. Inside EZ consistently decreased with time, as with controls. From these observations we began formulating a hypothesis that could account for all of these results and observations, which we discuss below.

### Discussion

An unexpected flow pattern was explored in these experiments, apparently related to the presence of a so-called exclusion zone. When a Nafion tube was immersed in water and a hole was punched in the tube wall, the water flowed continuously from the outside to the inside of the tube. Although the flow rate diminished with time, it reached a plateau that persisted for at least the full period of observation, which typically exceeded one hour. Hence, the flow was persistent. And, it was observable in every one of the approximately 40 experiments carried out.

Control experiments demonstrated that the flow was not the result of some kind of hydrostatic pressure differential, but was specific to some feature of the Nafion tubing. When silicon tubing of the same dimension was substituted, no flow was seen. One prominent feature of Nafion is the presence of large exclusion zones, or EZs adjacent to its surface (Zheng and Pollack, 2003; Zheng et al., 2006). Silicon tubing is hydrophobic, and shows no such zones. Hence, it appeared that some feature of Nafion's EZ-generating capacity of the Nafion might be responsible for inducing this flow.

We confirmed that flow rate depended on the size of the annular EZ inside the tubing. Increasing EZ size by adding base within the tubing increased flow magnitude, while diminishing inside EZ size by adding acid inside diminished the flow. We also found that dynamic changes of EZ size correlated with dynamic changes of flow. Hence, the evidence implied that some aspect of inside-EZ size might be responsible for driving the flow.

The driving mechanism may involve charge separation. The EZ is negatively charged, while the region beyond is positively charged as a result of proton release. The protons would be expected to combine immediately with water, creating hydronium ions, i.e., positively charged water. Hence, a possibility to explain the flow is that the positively charged water molecules are attracted by the negative potential of the inside exclusion zone. Once the tube is punctured, the positively charged water directly adjacent to the puncture will be strongly drawn toward the interior negativity. The farther-away molecules outside the tube are then drawn to the space previously held by the original molecules. Moving closer, these molecules will in turn feel the strong pull of the interior negativity, and will be drawn with equal vigor into the tube. Thus, the flow persists.

Additional mechanisms would contribute to the temporal decline in flow rate. The influx of protons into the tube effectively neutralizes the negatively charged EZ, diminishing internal EZ size. The decrease in EZ size in turn decreases the electrodynamic force exerted on the water molecules, which in turn leads to a lower flow rate. This negative feedback cycle would lead to exponential flow patterns similar to those described above.

While this mechanism seems consistent with observations, additional experiments will be required to test its detailed features and predictions. The main purpose here is to report this unexpected but consistent flow, and to speculate on the possible driving force. Other driving mechanisms may be possible, but the consistent correlation between EZ size and flow rate makes the present one attractive at least as a starting point.

Implicit in this persisting flow is some source of persisting driving energy, for baseline flow persists without apparent diminution for extended lengths of time, well beyond one hour. If it is the mechanism above that bears responsibility, then a likely source of energy is incident radiant energy, for EZ buildup is fueled by radiant energy, particularly in the infrared region. Hence, infrared energy might be the ultimate driving source for this persisting and counter-intuitive flow.

While various aspects and embodiments have been disclosed herein, other aspects and embodiments are contemplated. The various aspects and embodiments disclosed herein are for purposes of illustration and are not intended to be limiting, with the true scope and spirit being indicated by the following claims.

What is claimed is:

1. A fluid flow generator, comprising:
a tube having an inner wall, an inlet end, and an output end; and
a hydrophilic surface formed on at least a portion of the inner wall of the tube;
wherein the hydrophilic surface of the inner wall is configured to form a proximate exclusion zone in polar fluid in the tube, and the exclusion zone provides a propulsive force to drive fluid flow from the inlet end to the output end of the tube.

2. The fluid flow generator of claim 1, further comprising:
a first fluid reservoir coupled to admit the polar fluid to the inlet end of the tube; and
a second fluid reservoir coupled to receive the polar fluid from the output end of the tube.

3. The fluid flow generator of claim 1, further comprising:
a flow direction generator configured to generate a direction of flow.

4. The fluid flow generator of claim 3, wherein the flow direction generator is formed as a variation in a cross sectional area inside the tube.

5. The fluid flow generator of claim 3, wherein the flow direction generator is formed as a variation in hydrophilicity of the hydrophilic surface or as a variation in an area occupied by the hydrophilic surface.

6. The fluid flow generator of claim 3, wherein the flow direction generator includes a conventional pump, an energy source configured to apply differential energy to at least one portion of the tube compared to another portion of the tube, or a separate motive power source configured to move the tube through the polar fluid.

7. The fluid flow generator of claim 3, wherein the flow direction generator is configured to stop generating the direction of flow after the direction of flow is established.

8. The fluid flow generator of claim 3, wherein the flow direction generator is an exclusion zone taper generator.

9. The fluid flow generator of claim 8, wherein the exclusion zone taper generator is configured to establish a flow direction and generate a taper in a physical size of the exclusion zone.

10. The fluid flow generator of claim 1, wherein the inlet and output ends of the tube are interchangeable and the direction of fluid flow is substantially random.

11. The fluid flow generator of claim 1, wherein the tube is configured to receive incident energy and responsively maintain the exclusion zone and the propulsive force.

12. The fluid flow generator of claim 11, wherein the incident energy is sonic, ultrasonic, or electromagnetic energy.

13. The fluid flow generator of claim 1, further comprising:
an energy source configured to provide incident energy to at least one of the fluid, the tube, or the hydrophilic surface and drive at least one of formation or maintenance of the exclusion zone.

14. The fluid flow generator of claim 1, wherein at least one of the tube or the hydrophilic surface is made at least partially from Nafion or polyacrylic-acid gel.

15. The fluid flow generator of claim 1, wherein the polar fluid includes water, a polar fluid with one or more solutes, water with one or more solutes, a polar fluid with one or more suspended particle types, water with one or more suspended particle types, an alcohol, ethanol, a carboxylic acid, acetic acid, dimethyl sulfoxide, or deuterium oxide.

16. The fluid flow generator of claim 1, wherein the fluid flow generator is a portion of an irrigation system, a portion of water transport system from an aquifer or cistern, a portion of an infusion device, a portion of a toy or amusement, a portion of a heating system, a portion of a cooling system, a portion of a heating and cooling system, a portion of a fluid mixing system, a portion of an aquarium circulation system, a portion of a vessel propulsion system, a portion of a power generation system, a portion of a fluid tank, a portion of a piston engine, or a portion of a multi-stage pump.

17. The fluid flow generator of claim 1, wherein the exclusion zone is formed as a volume of rotationally aligned fluid molecules adjacent the hydrophilic surface.

18. The fluid flow generator of claim 1, wherein the exclusion zone forms a charged area, wherein fluid not in the exclusion zone forms an image charge responsive to the charge of the exclusion zone, and wherein the charge separation forms an energy source for driving flow of the fluid.

19. The fluid flow generator of claim 1, wherein the exclusion zone forms a state of reduced entropy, the entropy reduction being a function of exclusion zone thickness, and wherein fluid flow is driven by flow from a region of relatively low entropy corresponding to a thick exclusion zone to a region of relatively high entropy corresponding to a thin exclusion zone.

20. The fluid flow generator of claim 1, wherein the energy in the exclusion zone is provided at least in part from a portion of molecular kinetic energy corresponding to absolute temperature.

21. The fluid flow generator of claim 1, wherein the tube includes a plurality of tubes, each with a corresponding hydrophilic surface formed on at least a portion of the inner walls of the tubes.

22. The fluid flow generator of claim 21, wherein at least a portion of the plurality of tubes are each configured to receive the polar fluid from the output end of another tube.

23. The fluid flow generator of claim 22, further comprising at least one intermediate fluid reservoir, wherein a first tube is configured to pump fluid into the at least one intermediate fluid reservoir and a second tube is configured to pump fluid out of the at least one intermediate fluid reservoir.

24. The fluid flow generator of claim 21, wherein at least a portion of the plurality of tubes are each configured to receive the polar fluid from substantially a same source and output the polar fluid to substantially a same destination.

25. The fluid flow generator of claim 1, wherein the polar fluid is water, and further comprising:
a vessel configured to move through the water; and
a mount configured to couple the fluid flow generator to the vessel;
wherein the fluid flow generator is configured to at least aid in propelling the vessel through the water.

26. A method for pumping a polar fluid, comprising:
contacting a polar fluid with at least one hydrophilic surface;
forming at least one exclusion zone in the polar fluid proximate the at least one hydrophilic surface;
forming a difference in an exclusion zone characteristic between first and second regions of the at least one exclusion zone; and
propelling the polar fluid from a volume proximate the first region of the at least one exclusion zone to a volume proximate the second region of the at least one exclusion zone responsive to the difference in the characteristic.

27. The method for pumping a polar fluid of claim 26, wherein the polar fluid is propelled responsive to an exchange in energy between the at least one exclusion zone and a volume of bulk polar fluid adjacent to and outside the at least one exclusion zone.

28. The method for pumping a polar fluid of claim 26, wherein forming a difference in the exclusion zone characteristic between the first and second regions includes forming a direction of taper in the characteristic between the first and second regions relative to the at least one hydrophilic surface.

29. The method for pumping a polar fluid of claim 26, wherein the characteristic is exclusion zone thickness; and
wherein the first region exclusion zone thickness is greater than the second region exclusion zone thickness.

30. The method for pumping a polar fluid of claim 29, wherein the difference in the thickness between the first and second regions of the at least one exclusion zone includes a taper; and
wherein propelling the polar fluid includes propelling the fluid in a direction substantially parallel to the at least one hydrophilic surface with the taper in the at least one exclusion zone.

31. The method for pumping a polar fluid of claim 26, further comprising:
providing a tube having an inlet end and an output end with the at least one hydrophilic surface being disposed on the inside of the tube; and
wherein the polar fluid is propelled from the inlet end to the output end of the tube.

32. The method for pumping a polar fluid of claim 31, wherein the inlet end of the tube receives the polar fluid from a first reservoir and the output end of the tube outputs the polar fluid to a second reservoir.

33. The method for pumping a polar fluid of claim 26, further comprising:
providing a body with the at least one hydrophilic surface being disposed on the surface of the body; and
wherein the polar fluid is propelled substantially parallel to the surface of the body.

34. The method for pumping a polar fluid of claim 33, wherein the body is reactively driven through a volume of the polar fluid responsive to the propelling.

35. The method for pumping a polar fluid of claim 26, wherein the polar fluid mixed with bulk polar fluid responsive to the propelling.

36. The method for pumping a polar fluid of claim 26, further comprising:
providing a cylinder with at least one hydrophilic surface being disposed on the inside of the cylinder;
opening at least one passage through a wall of the cylinder; and
wherein propelling the polar fluid includes propelling the fluid from a volume outside the cylinder to the inside of the cylinder.

37. The method for pumping a polar fluid of claim 36, further comprising:
pushing a piston responsive to the propelling of the polar fluid from the volume outside the cylinder to the inside of the cylinder.

38. The method for pumping a polar fluid of claim 37, further comprising:
outputting mechanical rotation responsive to the pushing of the piston.

39. The method for pumping a polar fluid of claim 26, further comprising:
establishing a flow direction of the polar fluid relative to the at least one hydrophilic surface.

40. The method for pumping a polar fluid of claim 39, wherein the flow direction of the fluid flow is established by a flow direction generator.

41. The method for pumping a polar fluid of claim 40, wherein the flow direction generator is an exclusion zone taper generator.

42. The method for pumping a polar fluid of claim 39, wherein the flow direction is formed as a variation in the cross sectional area inside a tube on which the hydrophilic surface is disposed.

43. The method for pumping a polar fluid of claim 39, wherein the flow direction is established responsive to a variation in hydrophilicity of the at least one hydrophilic surface or as a variation in the area of the hydrophilic surface.

44. The method for pumping a polar fluid of claim 39, wherein the flow direction is established responsive to pumping by a conventional pump, differentially supplying energy to a first area of the at least one hydrophilic surface corresponding to the first region of the at least one exclusion zone compared to a second area of the at least one hydrophilic surface corresponding to the second region of the at least one exclusion zone, differentially supplying energy to a first portion of body supporting the at least one hydrophilic surface compared to a second portion of the body supporting the at least one hydrophilic surface, differentially supplying energy to a first volume of the polar fluid adjacent to or coincident with the first region of the at least one exclusion zone compared to a second volume of the polar fluid adjacent to or coincident with the second region of the at least one exclusion zone, or moving the at least one hydrophilic surface through the polar fluid.

45. The method for pumping a polar fluid of claim 39, further comprising:
stopping the establishing of the flow direction of the polar fluid relative to the at least one hydrophilic surface after the direction of flow is established.

46. The method for pumping a polar fluid of claim 26, wherein the least one hydrophilic surface is made at least partially from Nafion or polyacrylic-acid gel.

47. The method for pumping a polar fluid of claim 26, further comprising:
providing energy to at least one of the polar fluid, the at least one hydrophilic surface, or a substrate supporting the at least one hydrophilic surface.

48. The method for pumping a polar fluid of claim 47, wherein the energy drives at least one of formation or maintenance of the at least one exclusion zone.

49. The method for pumping a polar fluid of claim 42, wherein providing energy includes providing radiant energy, sonic energy, or ultrasonic energy.

50. A body configured to drive polar fluid to flow past the body, comprising:
a body having an external surface; and
a hydrophilic surface formed on at least a portion of the external surface;
wherein the hydrophilic surface is configured to form a proximate exclusion zone in polar fluid adjacent the body, and the exclusion zone provides a propulsive force to drive polar fluid flow substantially parallel to the surface of the body.

51. The body configured to drive fluid to flow past the body of claim 50, further comprising:
an exclusion zone taper generator configured to generate a direction of exclusion zone taper including regions of thick and thin exclusion zones proximate the body;
wherein the polar fluid is driven to flow along the surface of the body from a region having a thick exclusion zone to a region having a thin exclusion zone.

52. The body configured to drive fluid flow past the body of claim 50, further comprising:
a flow direction generator configured to generate a difference in an exclusion zone characteristic including regions of differing characteristic values proximate the body;
wherein the polar fluid is driven to flow along the surface of the body from a region having a first exclusion zone characteristic value to a region having a second exclusion zone characteristic value.

53. The body configured to drive fluid flow past the body of claim 52, wherein the exclusion zone characteristic is exclusion zone thickness.

54. The body configured to drive fluid to flow past the body of claim 52, wherein the flow direction generator includes a fluid agitator, a pump, or a propulsion system configured to drive the body through the polar fluid.

55. The body configured to drive fluid to flow past the body of claim 52, wherein the flow direction generator includes a variation in hydrophilicity of the hydrophilic surface or a variation in an area occupied by the hydrophilic surface.

56. The body configured to drive fluid to flow past the body of claim 50, further comprising an energy source configured to provide energy to the body, the hydrophilic surface, the exclusion zone, or bulk polar fluid disposed adjacent to the exclusion zone;
wherein the energy source is operable to establish or maintain a characteristic of the exclusion zone.

57. The body configured to drive fluid to flow past the body of claim 50, wherein at least one of the body or the hydrophilic surface is formed from Nafion or polyacrylic-acid gel.

58. The body configured to drive fluid to flow past the body of claim 50, wherein the body is configured as a fluid mixer.

59. The body configured to drive fluid to flow past the body of claim 50, wherein the body includes a hull of a vessel.
